(19) United States
(12) Patent Application Publication
(10) Pub. No.: US 2013/0301273 A1
(43) Pub. Date: Nov. 14, 2013

(54) HEAT SINK FOR AN ELECTRONIC COMPONENT

(71) Applicant: ALCOA INC., Pittsburgh, PA (US)

(72) Inventors: Edmund Chu, Export, PA (US); Kelly Whitaker-Weiler, Pittsburgh, PA (US); J.R. Bushik, North Huntingdon, PA (US); Jeffrey Shoup, Delmont, PA (US); Narsimhan Raghunathan, Export, PA (US); Luis Fanor Vega, Cheswick, PA (US); Jason Bely, New Kensington, PA (US); Gary L. Myers, Sarver, PA (US); Gary L. Hunker, North Apollo, PA (US); Barry E. Soxman, Tarentum, PA (US); Anthony J. Fedusa, Lower Burrell, PA (US); Robert E. Dick, Cheswick, PA (US); Darl G. Boysel, Delmont, PA (US); Eileen M. Kenzevich, Apollo, PA (US)

(73) Assignee: ALCOA INC., Pittsburgh, PA (US)

(21) Appl. No.: 13/837,733

(22) Filed: Mar. 15, 2013

Related U.S. Application Data
(60) Provisional application No. 61/614,284, filed on Mar. 22, 2012.

(51) Int. Cl. F21V 29/00

(52) U.S. Cl. CPC F21V 29/004
USPC 362/294; 362/382; 362/363

(57) ABSTRACT

A device for thermal management of an electronic component includes an inner shell dimensioned to house an electrical circuit and a thermally conductive metal outer shell. The metal outer shell has a thickness less than 6.3246 mm; a first closed end having a first diameter and dimensioned to support an electronic component operably connected to the electrical circuit; and a second end having a second diameter, wherein the first diameter is greater than the second diameter. The inner shell is at least partially within the outer shell. The outer shell is comprised of a single metal sheet. The thinnest portion of the outer metal shell is less than or equal to 0.75 times the thickest portion of the outer metal shell.

### CROSS-REFERENCE TO RELATED APPLICATIONS

This patent application claims priority to U.S. Provisional Patent Application No. 61/614,284, filed Mar. 22, 2012, which is incorporated herein by reference in its entirety.

### BACKGROUND

Light Emitting Diodes (LEDs) are light sources made from doped semiconductor materials. Light is emitted when electrons and holes combine in the P-N junction and emit photons. In addition to light, a large amount of the energy generated by an LED is released in the form of heat. High junction temperatures will decrease efficiency and lifetimes of the LED. Effective heat sinks for thermal management increase the efficiency and lifetime of LED light sources.

Existing LED heat sinks typically consist of finned designs using primarily die casting technologies. Other designs include extruded tubes plus inserted stamped fins.

### SUMMARY

A device comprises: an inner shell dimensioned to house an electrical circuit; and a thermally conductive metal outer shell. The outer shell is comprised of a single metal sheet. The thermally conductive metal outer shell has a thickness less than 0.249 inch (6.3246 mm); a first closed end having a first diameter and dimensioned to support an electronic component operably connected to the electrical circuit; and a second end having a second diameter. The first diameter is greater than the second diameter.

In some embodiments, the thickness of the metal outer shell decreases from the first closed end to the second end. In some embodiments, the thinnest portion of the outer metal shell is less than or equal to 0.75 times the thickest portion of the outer metal shell.

The tapered thickness of the outer shell can be defined either by a spherical distribution or an exponential distribution such as: Thickness=a*exp(b*Shell height) where 0.8<a<1.5; 0.008<b<0.03. Where a is the finished thickness at the lip (second end) of the shell and b is a parameter generated based on curve fitting of the maximum starting shell thickness and the finished lip thickness of the shell. In the equation, b is a function of starting and finish shell thickness and the shell height.

The inner shell is at least partially within the outer shell. In some embodiments, the inner shell is comprised of metal. In some embodiments, the inner shell is comprised of a single metal sheet. In some embodiments, the inner shell is comprised of plastic.

In some embodiments, the outer shell is in physical contact with the inner shell. In some embodiments, the second end of the outer shell is in physical contact with the inner shell proximate to a second end of the inner shell.

In some embodiments, the outer shell has a plurality of apertures between the first end and the second end of the outer shell.

In some embodiments, when heat is generated by an electronic component in thermal communication the first closed end of the thermally conductive outer shell, air is drawn through the apertures and cools via convention at least one of the inner shell, the outer shell and the electronic component.

In some embodiments, the single metal sheet comprising the outer shell is an aluminum sheet. In some embodiments, the outer shell is comprised of one of AA 1050, 1100, 3003, 3004 and 3104.

In some embodiments, an outer surface of the metal outer shell is flat. In some embodiments, an outer surface of the metal outer shell is corrugated. In some embodiments, at least a portion of a surface of the outer shell has an Ra value in the range of 5 μin to 200 μin. In some embodiments, at least a portion of a surface of the outer shell has an Ra value in the range of 6.5 μin to 120 μin. In some embodiments, at least a portion of a surface of the outer shell has an Ra value in the range of 6.5 μin to 110 μin. In some embodiments, at least a portion of a surface of the outer shell has an Ra value in the range of 8.5 μin to 15 μin. In some embodiments, at least a portion of a surface of the outer shell has an Ra value in the range of 104 μin to 120 μin. In some embodiments, the outer shell has a textured surface finish wherein the texture is created by one of mechanical roughening and coating. In some embodiments, the outer shell is at least partially coated with graphite.

In some embodiments, the first closed end of the metal outer shell is dimensioned to support a light emitting diode.

In some embodiments, the device further comprises a dome covering the first closed end of the metal outer shell, wherein the dome is transparent or translucent to light.

In some embodiments, the device further comprises a light reflector on the first closed end of the metal outer shell.

One embodiment includes a heat sink comprising: a thermally conductive inner metal shell; a thermally conductive support plate covering a first end of the metal inner shell and dimensioned to support an electronic component; and a thermally conductive outer shell. Some embodiments also include a face surrounding the support plate. The thermally conductive outer shell comprises a first end having a first diameter and a second end having a second diameter. In some embodiments, the second diameter is smaller than the first diameter. The inner shell is at least partially within the outer shell. The outer shell is in thermal communication with the support plate.

The electronic component may be any digital or analog discrete or integrated semiconductor device, including optoelectronic devices, such as a light emitting diodes (“LED's”) or organic light emitting diodes (“OLED's”). In operation a heat generating electronic component is in thermal communication with the support plate.

The support plate is in thermal communication with the inner shell and the outer shell. In some embodiments, the support plate is also in thermal communication with the face. Thermal communication can be realized by direct or indirect physical contact.

In some embodiments, the support plate is in direct physical contact with the inner shell. For example, the support plate can be dimensioned to rest upon a first end of the inner shell, be frictionally engaged with the first end of the inner shell or may be attached to the first end of the inner shell by any mechanical attachment, shrink fit, soldering, a thermally conductive adhesive, welding or any means known in the art. In some embodiments, the support plate and the inner shell are a single component comprised of a single piece of metal and may be integrally formed from a single piece of metal.

In some embodiments, the inner shell and the outer shell are in direct physical contact. For example, in some embodiments, the inner shell and the outer shell are in direct physical contact proximate to their respective second ends. In some embodiments, the outer surface of the second end of the inner shell is in direct physical contact with the inner surface of the second end of the outer shell. Because, in this arrangement, the inner shell is thermally conductive and in direct physical contact with the support plate, the outer shell is in thermal communication with the support plate via indirect physical contact.

In another embodiment, the inner shell and the outer shell are integrally formed from a single metal sheet.

In some embodiments, a thermally conductive face surrounds and is in direct physical contact with the support plate. In some embodiments, the face is ring-shaped and forms a ring surrounding the support plate. In some embodiments, the support plate and the face are comprised of a single piece of metal and are integrally formed from a single piece of metal. In some embodiments, the face is in direct physical contact with the inner shell proximate to the first end of the inner shell. In some embodiments, the face and the inner shell are comprised of a single piece of metal and are integrally formed from a single piece of metal.

In some embodiments, the face is in direct physical contact with the outer shell proximate to the first end of the outer shell. For example, the face can have a diameter about equal to the inner diameter of the first end of the outer shell. The outer shell at least partially surrounds the inner shell and the outer diameter of the face frictionally engages the inner diameter of the first end of the outer shell. In some embodiments, the face and the outer shell are integrally formed from a single piece of metal sheet.

In some embodiments, the face is ring-shaped and forms a ring surrounding the support plate. In some embodiments, the face has a plurality of apertures. In some embodiments, the face is comprised of a plurality of spokes.

The outer shell and/or the face may have a variety of surface features. In some embodiments, the outer shell and/or the face has a plurality of apertures. Apertures on the outer shell lie between the first end and the second end. The apertures may take a variety of forms and be or any size or shape, including but not limited to, circular, oval, rectangular, triangular, non-symmetrical, or irregular shaped holes or slots. In some embodiments, the outer shell and/or the face is comprised of a plurality of spokes. In some embodiments, the apertures are arranged in a symmetrical or an asymmetrical pattern on the outer shell and/or the face. In some cases the apertures in the face may be oriented with respect to those in the outer shell to optimize cooling of the support plate. The apertures may cover any percentage of the surface area of the outer shell and/or the face, such as less than 10%, 10%, 20%, 30%, 40%, 50%, 60%, 70%, 80% and 90%. In some embodiments, the outer shell may be free of apertures between the first end and the second end. In some embodiments, the face may form a ring free of apertures.

In some embodiments, the surface of the outer shell and/or face is flat. In other embodiments, the outer shell and/or face is corrugated. Corrugations can be formed by any method known in the art such as stamping. The outer shell may take a variety of shapes. For example, the outer shell may be frustoconical or may have a curved shape, like a lower portion of a standard incandescent light bulb.

In some embodiments the surface of the outer shell and/or face is textured, i.e. has an Ra value of at least 25 μin. In some embodiments, the surface finish of the outer shell and/or face has an Ra value in the range of 7 μin to 200 μin. The textured surface can be created in a variety of ways including mechanical roughening, such as peening, coating the outer shell with liquid or powder paints, or in any other manner known in the art, including the following:

Physical Modification:

shot-peening/blasting, texturing, embossing, electro-discharge texturing, polishing

Benefits:
Uniform non-directional appearance
Formability benefits for lubricant flow
Enhanced thermal performance due to increased surface area and emissivity

Surface Roughness Ranges:

| | |
|---|---|
| Ra (μin) | Rz (μin) |

| | min | max | min | max |
|---|---|---|---|---|
| Transverse | 12.5 | 107.3 | 73.3 | 480.0 |
| Longitudinal | 6.9 | 105.5 | 40.0 | 437.1 |

1. Chemical Modification:

Cleaning, Pretreatment, chemical or electrochemical polishing, conversion coating, electrochemical oxidation, Anodizing, Coating

Benefits:
Enhanced appearance
Enhanced durability in operating environment
Enhanced thermal performance

Surface Roughness Ranges:

| | |
|---|---|
| Ra (μin) | Rz (μin) |

| | min | max | min | max |
|---|---|---|---|---|
| Transverse | 13.0 | 14.4 | 72.7 | 88.9 |
| Longitudinal | 8.6 | 9.6 | 47.6 | 56.8 |

2. Physical and Chemical Modification:
Layering of treatments (ex. shot peening then anodizing, Electro graining followed by coating)
Physical change caused by a chemical process (surface etching, texturing, patterning)

Benefits:
Could have benefits of both categories above

Surface Roughness Ranges:

| | |
|---|---|
| Ra (μin) | Rz (μin) |

| | min | max | min | max |
|---|---|---|---|---|
| Transverse | 105.9 | 116.6 | 470.1 | 536.5 |
| Longitudinal | 104.3 | 112.7 | 417.0 | 473.2 |

In some embodiments, at least one of the inner shell, the outer shell, the face and the support plate is at least partially corrugated. In some embodiments, at least one of the inner shell, the outer shell, the face and the support plate is at least partially covered in graphite. In some embodiments the surface of at least one of the inner shell, the outer shell, the face and the support plate is textured, i.e. has an Ra value of at least 25 μin. The textured surface can be created in a variety of ways as described above with respect to the outer shell.

In some embodiments, the surface finish of at least one of the inner shell, the outer shell, the face and the support plate has an Ra value in the range of 7 μin to 200 μin. In some embodiments, at least a portion of a surface of the inner shell, the outer shell, the face and the support plate has an Ra value in the range of 5 μin to 200 μin. In some embodiments, at least a portion of a surface of the inner shell, the outer shell, the face and the support plate has an Ra value in the range of 6.5 μin to 120 μin. In some embodiments, at least a portion of a surface of the inner shell, the outer shell, the face and the support plate has an Ra value in the range of 6.5 μin to 110 μin. In some embodiments, at least a portion of a surface of the inner shell, the outer shell, the face and the support plate has an Ra value in the range of 8.5 μin to 15 μin. In some embodiments, at least a portion of a surface of the inner shell, the outer shell, the face and the support plate has an Ra value in the range of 104 μin to 120 μin. In some embodiments, at least a portion of a surface of the inner shell, the outer shell, the face and the support plate has an Rz value in the range of 35 μin to 540 μin. In some embodiments, at least a portion of a surface of the inner shell, the outer shell, the face and the support plate has an Rz value in the range of 35 μin to 485 μin. In some embodiments, at least a portion of a surface of the inner shell, the outer shell, the face and the support plate has an Rz value in the range of 45 μin to 95 μin. In some embodiments, at least a portion of a surface of the inner shell, the outer shell, the face and the support plate has an Rz value in the range of 415 μin to 540 μin.

In some embodiments, a surface texture is formed on the entire heat sink structure after it is formed and assembled. In some embodiments, the following flow path can be used to form the surface texture.

### Pretreatment:

Non-chromium pretreatment for adhesion promotion
   Electroless: Ti, Zr phosphates, phosphonates with organic functional chain (e.g. ALX009),
   Electrochemical oxidation: phosphoric acid or boric acid anodizing

### Coating:

Polyester, Acrylic, Polyurethane, Fluorinated coatings, such as PVDF, either in powder or liquid form. Siloxanes, Polysiloxanes. Hybrid siloxanes with organic functional groups
   Thickness range: ˜5 micrometers to 75 micrometers
Electrochemical Oxidation:
   Phosphoric acid, Boric acid, Oxalic acid, Tartaric acid, Gluconic acid and mixtures thereof,
Additives for above coatings
   Particle dispersion to affect topography
      SiO₂, ZrO₂, TiO₂, Al2O3, WC (Tungsten Carbide), BC (Boron Carbide) or other similarly sized particle of different composition.
      Particle size: 40 nanometers to 25 micrometers
         Topography Techniques that May be Used to Create a Textured Surface:
Arc graining, Electrochemical graining, Electrodischarge graining
Barrel peening
Shot peening, Blast peening

In some embodiments, corrugation and/or the textured surface increases the surface area of the heat sink and cooling of at least one the inner shell, the outer shell, the support plate, the face and the electronic component via conduction. The corrugation may aid in the creation of turbulent air flow that cools at least one the inner shell, the outer shell, the support plate, the face and the electronic component via convection or advection.

The surface features, including apertures, corrugation and texture described above and the configuration of the surface features can be dimensioned and arranged to increase air flow around the heat sink and increase the surface area of the heat sink. The increase in air flow aids in the cooling of at least one of the support plate, the electronic component, the inner shell, the outer shell and the face via convection or advection. The increase in surface area aids in the cooling of at least one of the support plate, the electronic component, the inner shell, the outer shell and the face via conduction.

When heat is generated by an electronic component in thermal communication with the support plate, air surrounding the support plate is heated and the heated air travels upward. The upward flow of heated air draws cooler air through the apertures in the outer shell and/or face and cools via convention and/or advection at least one of the outer shell, the inner shell, the support plate, the face and the electronic component. The exact path of the air flow will depend of the orientation of the heat sink and the arrangement and dimension of apertures and other surface features of the heat sink. For example, in some embodiments, when the heat sink is oriented so that the support plate is above at least most of the outer shell, heated air surrounding the support plate may flow upward through apertures in the face, drawing cooler air into the outer shell through apertures of the outer shell. The cooled air would pass by and cool the inner shell and travel upward to cool the support plate. As the air heats up it travels upward and escapes through the apertures in the face, continuing a cycle of airflow that aids in the cooling of the support plate and the electronic component. The air flow may undergo irregular fluctuations, movement, or mixing. The speed of the air flow at a point may be continuously undergoing changes in both magnitude and direction. The open slots on both the face and the outer shell and other features of the heat sink can be designed and arranged in such a way to create desired air movement enabling efficient cooling of the electronic component.

The inner shell, the outer shell, the face and the support plate may be comprised of aluminum, or aluminum alloys, copper or copper alloys, magnesium or magnesium alloys, iron or iron alloys or any other thermally conductive material. Aluminum and aluminum alloys are collectively referred to as “aluminum” herein. In some embodiments, at least one of the inner shell, the outer shell, the face and the support plate is comprised of aluminum. Any suitable aluminum alloy may be used, including but not limited to any 1xxx, 2xxx, 3xxx, 4xxx, 5xxx, 6xxx, 7xxx and 8xxx series alloys including AA1050, 1100, 3003, 3004, 3104, 3105, 6061 and 6063. Alloys can be selected to achieve certain desired characteristics such as desired strength, formability and thermal conductivity.

In some embodiments, at least one of the inner, shell, the outer shell or the face are composed of polymeric or ceramic materials.

In some embodiments, the inner shell and the outer shell are concentric. In some embodiments the inner shell, the outer shell, the support plate and the face are concentric. In some embodiments the inner shell is tube-shaped and resides substantially within the outer shell. In some embodiments of the heat sink, the outer shell is open on both the first end and the second end. In some embodiments of the heat sink, the second end of the inner shell is open.

In some embodiments, when the heat sink forms part of a housing for an LED or other device, the inner shell and the support plate form at least part of an enclosure of electronics, protecting the electronics from water and other harmful elements. The LED or other device rests upon the support plate. The support plate can have a small hole or holes to accommodate wires between the LED and the electronics within the inner shell. When the housing is in the form of a light bulb, a screw base portion of the light bulb, operatively attached to the electronics of the LED and dimensioned for operable connection to an electrical light fixture, passes through and may close off the opening at the second end of the outer shell. In some embodiments, pins or other means of conducting external current may be used in place of the screw base. The heat sink may comprise additional components used to electrically isolate the base from at least one of the inner shell or outer shell.

In some embodiments, the inner shell forms at least part of an enclosure of electronics, protecting the electronics from water and other harmful elements. The LED or other device rests upon the first closed end of the metal outer shell, a.k.a the support plate. The first closed end of the metal outer shell can have a small hole or holes to accommodate wires between the LED and the electronics within the inner shell. When the device is in the form of a light bulb, a screw base portion of the light bulb, operatively attached to the electronics of the LED and dimensioned for operable connection to an electrical light fixture, passes through and may close off the opening at the second end of the outer shell. In some embodiments, pins or other means of conducting external current may be used in place of the screw base. The device may comprise additional components used to electrically isolate the base from at least one of the inner shell or outer shell.

In some embodiments, the device or housing for an LED device further comprises a dome covering the support plate, wherein the dome is transparent or translucent to light or even alters the light emitted by the electronic device. In some embodiment, the face is at least partially outside of the dome and an outer dome covers the inner dome, the support plate and the face. In embodiments wherein the face and the outer shell have apertures, having an inner dome covering the support plate and an LED on the support plate and an outer dome covering the inner dome, the support plate and the face enables the LED to be protected while air is drawn in through the apertures in the outer shell and passes through the apertures in the face between the inner dome and the outer dome.

In some embodiments, at least some of the surface of at least one of the support plate, the face, the inner shell and the outer shell is reflective in order to increase the light output of the LED. In some embodiments, wherein the face and the outer shell have apertures, the heat sink and housing are dimensioned so that light from the LED passes through the apertures in the face and the outer shell.

Any of the outer shell, inner shell, face and support plate can be formed from a metal sheet or a slug. An aluminum slug is a round piece of aluminum typically sheared from a rod or punched from a sheet. A metal sheet is a rolled metal product having a thickness of from 0.006 inch (0.1524 mm) to 0.249 inch (6.3246 mm). In some embodiments, the thickness of the metal sheet is in the range of about 0.2 mm-2 mm. In some embodiments, the outer shell is formed from an aluminum sheet having a thickness in the range of 0.2 mm-2 mm. In some embodiments, the thickness of the outer shell is in the range of 0.006 inch (0.1524 mm) to 0.249 inch (6.3246 mm); 0.2 mm to 2 mm; 0.4 mm to 1 mm; 0.4 mm to 0.8 mm or 0.4 mm to less than 1 mm. In some embodiments, the thickness of the outer shell is variable. For example, the outer shell may be thickest at the first end with the thickness tapering and being thinnest at the second end. In some embodiments, the thickest portion of the outer shell is less than 7 mm, less than or equal to 6.3246 mm; less than 6 mm, less than 5 mm, less than 4 mm, less than 3 mm, less than 2 mm or less than 1 mm.

In some embodiments, the thickness of the inner shell is in the range of 0.006 inch (0.1524 mm) to 0.249 inch (6.3246 mm); 0.2 mm to 2 mm; 0.4 mm to 1 mm; 0.4 mm to 0.8 mm; or 0.4 mm to less than 1 mm. In some embodiments, the thickness of the inner shell is variable. For example, the inner shell may be thickest at the first end with the thickness tapering and being thinnest at the second end. In some embodiments, the thickest portion of the inner shell is less than 7 mm, less than or equal to 6.3246 mm; less than 6 mm, less than 5 mm, less than 4 mm, less than 3 mm, less than 2 mm or less than 1 mm.

In some embodiments, the thickness of the support plate is in the range of 0.006 inch (0.1524 mm) to 0.249 inch (6.3246 mm); 0.2 mm-5 mm; 0.2 mm to 2 mm; 0.4 mm to 0.8 mm; 0.4 mm to 1 mm; or 0.4 mm to less than 1 mm. In some embodiments, the thickest portion of the support plate is less than 7 mm, less than or equal to 6.3246 mm; less than 6 mm, less than 5 mm, less than 4 mm, less than 3 mm, less than 2 mm or less than 1 mm.

In some embodiments, the thickness of the face is in the range of 0.006 inch (0.1524 mm) to 0.249 inch (6.3246 mm); 0.2 mm-5 mm; 0.2 mm to 2 mm; 0.4 mm to 1 mm; 0.4 mm to 0.8 mm; or 0.4 mm to less than 1 mm. In some embodiments, the thickest portion of the face is less than 7 mm, less than or equal to 6.3246 mm; less than 6 mm, less than 5 mm, less than 4 mm, less than 3 mm, less than 2 mm or less than 1 mm.

In some embodiments, the thickness of any of the components of the heat sink can vary and be engineered to achieve a desired heat distribution. For example, the heat sink can be engineered so that the metal closest to the electronic components generating heat is thicker than metal more distant from the electronic components generating heat in order to optimize the balance between the amount of metal comprising the heat sink and the amount of heat removed from the electronic components.

In some embodiments, when the outer shell, support plate and face are a unitary structure comprised of a single metal sheet, the support plate, face and the first end of the outer shell all have the same thickness and the thickness of the outer shell gradually becomes thinner toward the second end.

In some embodiments, the thinnest portion of the outer metal shell is less than or equal to 0.75 times the thickest portion of the outer metal shell. In some embodiments, the ratio of thickness of metal at the first end/the thickness of metal at the second end is in the range of 3.0-0.5. In some embodiments, the ratio of thickness of metal at the first end/the thickness of metal at the second end is in the range of 3.0-1.5. In some embodiments, the ratio of thickness of metal at the first end/the thickness of metal at the second end is in the range of 2.0-1.5. In some embodiments, the ratio of thickness of metal at the first end/the thickness of metal at the second end is in the range of 3.0-2.5. In some embodiments, the ratio of thickness of metal at the first end/the thickness of metal at the second end is 1.46. In one embodiment, the length of the outer shell is 45 mm, the outer diameter of the first end of the outer shell is 80.2 mm, the thickness of the outer shell at the first end is 2 mm and, the ratio of thickness of metal at the first end/the thickness of metal at the second end is 1.46.

Forming at least some of the components of the heat sink from metal sheet, aluminum sheet, aluminum tube or an aluminum slug, as opposed to die casting aluminum in order to form the components, enables a reduction in thickness of the components of the heat sink, reduces the amount of metal comprising the heat sink and reduces the mass of the heat sink. Because the surface features can be engineered to optimize heat removal via conduction, convection and advection as described above, embodiments of heat sinks described herein are able to remove sufficient heat from electronic devices, including LED devices, using less metal and having less mass than prior art aluminum die cast heat sinks. For example, some embodiments of heat sinks described herein have 10%, 20%, 30%, 40%, 50%, 60%, 70%, 80% or 90% less mass than prior art die cast heat sinks having similar or identical heat removal capabilities.

In some embodiments, one of the outer shell, the inner shell, the face and the support plate may be formed by die casting.

Embodiments of the heat sink are engineered to have sufficient strength and rigidity to withstand use as intended, for example as part of a housing for an LED. Strength and rigidity depend on several factors, including but not limited to the thickness of the metal comprising the components of the heat sink, the specific alloys of the metal, the arrangement and dimensions of the surface features.

### Methods of Forming the Outer Shell

Method A—Forming the Outer Shell from a Cylinder

One method of forming the outer shell starts with forming an aluminum cylinder. The cylinder can be formed by any method known in the art including extruding an aluminum cylinder and rolling an aluminum sheet into a cylinder and attaching the sides. The sides can be attached by seaming, spot welding, an adhesive, a clip, a metal channel locking mechanism or any manner known in the art.

In one embodiment, an aluminum sheet is formed into a cylinder having a closed end. The cylinder can be formed in many ways, including but not limited to, drawing and redrawing, drawing and ironing, or deep drawing aluminum sheet. In other embodiments, a cylinder having a closed end is formed by impact extruding an aluminum slug. Any method of making an aluminum cylinder having a closed end known in the art may be used, such as those known and used to make aluminum containers. “Aluminum containers” as used herein includes, but is not limited to, beverage cans, aerosol cans, food cans and bottles.

To create the desired shape of the outer shell, portions of the cylinder can be expanded and/or narrowed by any methods known in the art, including those used to form aluminum containers. For example the cylinder can be expanded and/or narrowed using expansion and/or necking dies as described is U.S. Pat. Nos. 5,355,710; 5,557,963; 5,713,235; 5,718,352; 5,778,723; 5,822,843; 7,726,165; 7,934,410; and 7,954,354. The cylinder can also be expanded and/or narrowed using electromagnetic forming, as described in U.S. Pat. Nos. 4,947,667; 5,058,408; and 5,776,270, mechanical forming, blowforming or hydroforming.

In some embodiments, the outer shell is made by drawing, redrawing and partially redrawing an aluminum sheet into the desired final shape of the outer shell. Partially redrawing is redrawing less than the entire height of the cylinder formed from the sheet in previous forming operations, such as drawing. A method drawing, redrawing and partially redrawing to form a desired shape is described in U.S. Pat. No. 6,010,028.

A closed end of the cylinder or shaped form can be removed by electromagnetic forming, stamping or piercing or any other method known in the art. When starting with a cylinder having a closed end, the closed end can be removed either before or after shaping the cylinder. In some embodiments, the closed end is not removed.

Apertures can be made in the outer shell by any method known the art. For example, the apertures can be made by drilling or other machining methods, electromagnetic forming, shearing, punching, or puncturing the outer shell from the outside thereby forming tabs on inside. An outer shell having apertures with tabs on the inside can be seen in FIG. 43.

In some embodiments, apertures are made in a cylinder before it is shaped. Apertures can be made in the cylinder by punching, for example.

In some embodiments, apertures are made in the flat sheet before it is formed into a cylinder or outer shell. Apertures can be designed into the initial sheet to allow for deformation during the forming process. Apertures can be made in the flat sheet by stamping, for example.

Method B—Forming the Outer Shell Out of an Aluminum Sheet Having Apertures

In another method of forming the outer shell, apertures are made in an aluminum sheet. The sheet can be cut so that it takes a flat, frustoconical shape, for example. Then the sides of the aluminum sheet are rolled over to form a frustoconical cylinder and attached together. Alternatively, apertures can be made in the sheet after it has a flat, frustoconical shape. The sides can be attached by seaming, spot welding, an adhesive, a clip, a metal channel locking mechanism or any manner known in the art. The apertures can be made by stamping or any manner known in the art.

In another embodiment, an aluminum wire mesh sheet is cut so that it takes a flat, frustoconical shape. Then the sides of the aluminum sheet are rolled over to form a frustoconical cylinder and attached together. The sides can be attached by any methods discussed in this section above.

Method C—Forming the Outer Shell and the Inner Shell as a Unitary Structure

In one embodiment, the outer shell and the inner shell are integrally formed from a single piece of aluminum sheet. An aluminum sheet 10 is drawn and partially redrawn multiple times to form the structure shown in cross-section in FIG. 1. Then, the structure is partially reverse redrawn to form the inner shell outer shell unitary structure 20 shown in FIG. 2 in cross-section. The inner shell 22, support plate 24 and outer shell 26 can be seen. Apertures can then be made in the outer shell 26, as described above, or the outer shell 26 can remain aperture-free. The metal covering the first end 25 of the inner shell 22, which is shown closed, can be removed by stamping or piercing or the closed end can be allowed to remain to form an outer shell, inner shell, support plate unitary structure 20.

Alternatively, an aluminum sheet is drawn and partially redrawn to form the structure shown in FIG. 3 in cross-section. Apertures can be formed in the portion 33 of the structure that will become the outer shell by stamping. Then the portion 33 of the structure of FIG. 3 that will become the outer shell can be bent to partially surround the inner shell and form the structure shown in FIG. 2 in cross-section. The metal covering the first end 35 of the inner shell 32 can be removed by stamping or piercing or the closed end can be allowed to remain to form an outer shell, inner shell support plate unitary structure.

Another method of forming the inner shell and outer shell as a unitary structure comprises forming an aluminum cylinder by any method, including methods already described herein, longitudinally slicing a portion of the cylinder to form the structure shown in FIG. 4 in cross-section and folding the sliced portion 40 to partially surround the non-sliced portion 41 as shown in FIG. 5 in cross-section. The sliced portion 40 forms an outer shell 46 having apertures 49 and the non-sliced portion 41 forms the inner shell 42 and the support plate 44.

### Methods of Forming the Inner Shell

The inner shell can be made by any method known in the art. Here are some examples.

The inner shell can be formed by extruding aluminum to form an aluminum cylinder, which can serve as the inner shell. The extruded cylinder can be extruded to the desired length or cut to the desired length.

The inner shell can be formed by drawing and redrawing or drawing and ironing an aluminum sheet into a cylinder having one end closed, or impact extruding a slug into cylinder having a closed end. The resulting cylinder having one closed end can serve as the inner shell with an integral support plate, i.e. an inner shell and support plate unitary structure as shown in FIGS. 8 and 9, or the metal covering one end of the cylinder can be removed by stamping or piercing to form a cylinder having two open ends as shown in FIGS. 6 and 7.

In another embodiment, the inner shell is formed by drawing and partially redrawing an aluminum sheet to form T-shaped structure that forms an inner shell with an integral face as shown in FIGS. 10 and 11.

In some embodiments, the portion that makes up the face of the inner shell and face unitary structure can be stamped to form apertures therein.

A plastic inner shell can be made by any method known in the art including injection molding.

### Methods of Forming the Support Plate and the Face

In addition to the methods described above, the support plate and the face can be formed by stamping a unitary structure comprising a face and a support plate or stamping separate structures out of an aluminum sheet. A hole or holes in the support plate to accommodate the wires connecting the LED to the electronics housed in the inner shell can be made by blanking out a hole in the center of the support plate. A hole in the support plate can be made in the same way in conjunction with the other methods of forming a support plate described above. The stamped structure can be formed with an indentation to help with alignment when blanking out a hole in the center of the support plate. An indentation can also be used to align the support plate with the inner shell.

### BRIEF DESCRIPTION OF THE DRAWINGS

The following detailed description, given by way of example and not intended to limit the invention solely thereto, will best be appreciated in conjunction with the accompanying drawings, wherein like reference numerals denote like elements and parts, in which:

FIG. 1 depicts a cross-section of a metal sheet drawn and partially redrawn;

FIG. 2 depicts a cross-section of a unitary structure comprising an inner shell and an outer shell;

FIG. 3 depicts a cross-section of a metal sheet drawn and partially redrawn;

FIG. 4 depicts a cross-section of a metal cylinder wherein the bottom half of the cylinder is sliced into metal strips;

FIG. 5 depicts a cross-section of the metal cylinder of FIG. 4 after the metal strips have been folded to partially surround the non-sliced portion;

FIG. 6 depicts a side perspective cross-sectional view of a heat sink according to one embodiment;

FIG. 7 depicts a side view in partial cross-section of the heat sink of FIG. 6;

FIG. 8 depicts a perspective partial cross-sectional view of a heat sink according to another embodiment;

FIG. 9 depicts a side view in partial cross-section of the heat sink of FIG. 8;

FIG. 10 depicts a perspective partial cross-sectional view of a heat sink according to another embodiment;

FIG. 11 depicts a side view in partial cross-section of the heat sink of FIG. 10;

FIG. 12 depicts a perspective partial cross-sectional view of a heat sink according to another embodiment;

FIG. 13 depicts a side view in partial cross-section of the heat sink of FIG. 12;

FIG. 14 depicts a perspective partial cross-sectional view of an outer shell according to one embodiment;

FIG. 15 depicts a side view in partial cross-section of the outer shell of FIG. 14;

FIG. 16 depicts a perspective partial cross-sectional view of an outer shell according to another embodiment;

FIG. 17 depicts a side view in partial cross-section of the outer shell of FIG. 16;

FIG. 18 depicts a side perspective view of one embodiment of a housing for an LED;

FIG. 19 depicts a side view in partial cross-section of the housing of FIG. 18;

FIG. 20 shows a side exploded view of the housing of FIGS. 18 and 19;

FIG. 21 depicts a side perspective view of another embodiment of a housing for an LED;

FIG. 22 depicts a side view in partial cross-section of the housing of FIG. 21;

FIG. 23 shows a side exploded view of the housing of FIGS. 21 and 22;

FIG. 24 shows several views of an outer shell that may form part of a heat sink according to some embodiments;

FIG. 25 shows several views of an outer shell that may form part of a heat sink according to some embodiments;

FIG. 26 shows several views of an outer shell that may form part of a heat sink according to some embodiments;

FIG. 27 depicts a top view and a side view of a unitary structure comprising a support plate and a face according to one embodiment;

FIG. 28 depicts a top view and a side view of a unitary structure comprising a support plate and a face according to another embodiment;

FIG. 29a shows a top view of a unitary structure comprising an inner shell and a face according to one embodiment;

FIG. 29b shows a side cross-section view of the structure shown in 29a;

FIG. 30a depicts a top view of a support plate according to one embodiment;

FIG. 30b shows the support plate of FIG. 30a in cross-section;

FIG. 31 shows a side view and a side perspective view of an outer shell that may form part of a heat sink according to some embodiments;

FIG. 32 shows a side view and a side perspective view of an outer shell that may form part of a heat sink according to some embodiments;

FIG. 33 shows a side view and a side perspective view of an outer shell that may form part of a heat sink according to some embodiments;

FIG. 34 shows a side view and a side perspective view of an outer shell that may form part of a heat sink according to some embodiments;

FIG. 35 shows a side view and a side perspective view of an outer shell that may form part of a heat sink according to some embodiments;

FIG. 36 shows a side view and a side perspective view of an outer shell that may form part of a heat sink according to some embodiments;

FIG. 37 shows a side view and a side perspective view of an outer shell that may form part of a heat sink according to some embodiments;

FIG. 38 shows a side view and a side perspective view of an outer shell that may form part of a heat sink according to some embodiments;

FIG. 39 shows a side view and a side perspective view of an outer shell that may form part of a heat sink according to some embodiments;

FIG. 40 shows a side view and a side perspective view of an outer shell that may form part of a heat sink according to some embodiments;

FIG. 41 shows a side view, a bottom view and two side perspective views of an outer shell that may form part of a heat sink according to some embodiments;

FIG. 42 shows a side view and a side perspective view of an outer shell that may form part of a heat sink according to some embodiments;

FIG. 43 shows a side view and a side perspective view of an outer shell that may form part of a heat sink according to some embodiments;

FIG. 44 shows a side view and a side perspective view of an outer shell that may form part of a heat sink according to some embodiments;

FIG. 45 shows a side view in partial cross-section of a heat sink according to one embodiment;

FIG. 46 shows a side view of a heat sink according to one embodiment;

FIG. 47 shows a cross-sectional side view of the heat sink of FIG. 45;

FIG. 48 shows an exploded side view of the heat sink in FIGS. 45 and 46;

FIG. 49 shows an exploded perspective view of the heat sink in FIGS. 45, 46 and 47;

FIG. 50 shows a side view of a heat sink according to another embodiment;

FIG. 51 shows a cross-sectional side view of the heat sink of FIG. 49;

FIG. 52 shows an exploded side view of the heat sink in FIGS. 49 and 50;

FIG. 53 shows an exploded perspective view of the heat sink in FIGS. 49, 50 and 51; and

FIG. 54 shows a possible manufacturing flow path to manufacture one embodiment of a heat sink.

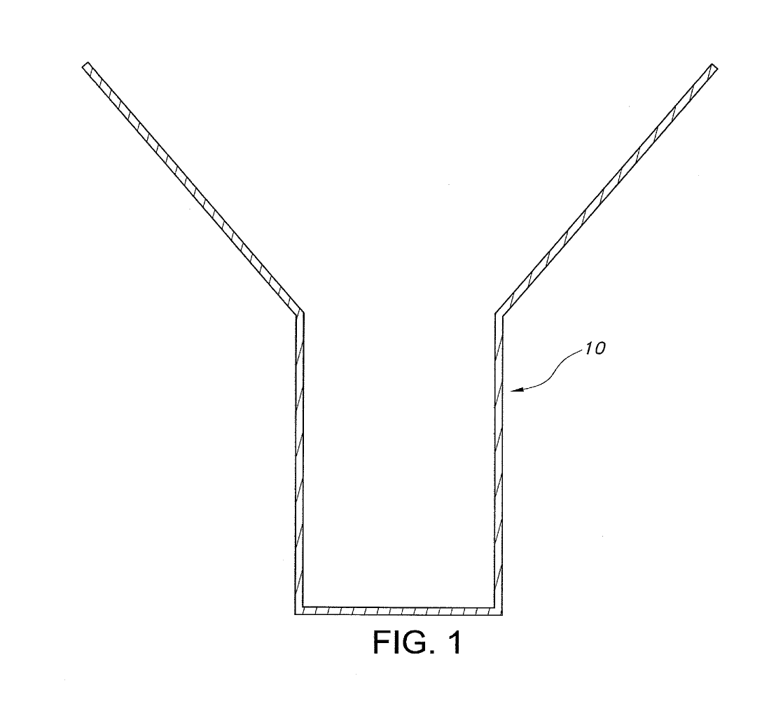

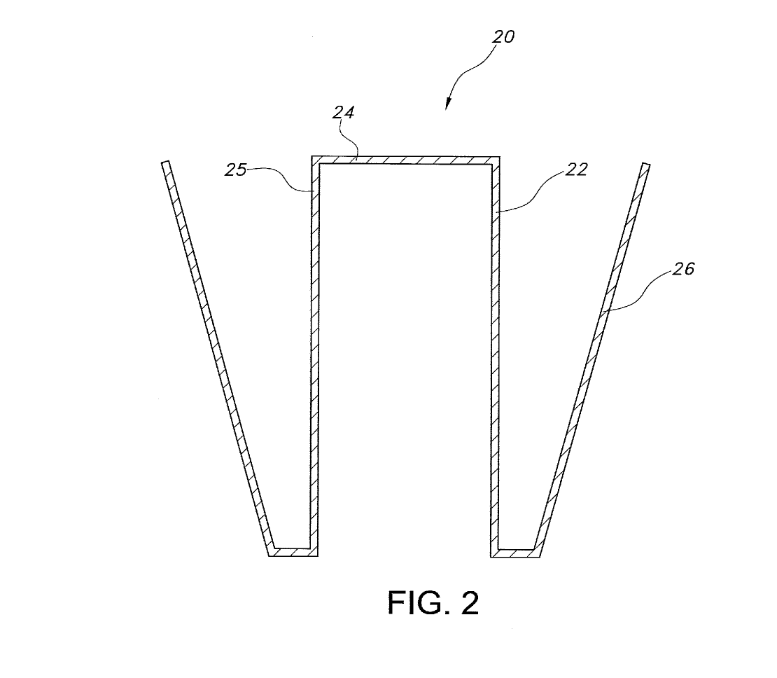

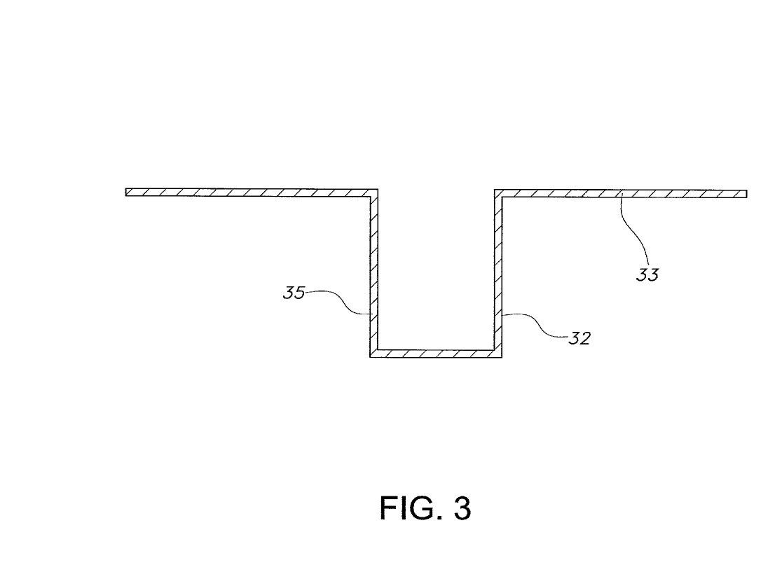

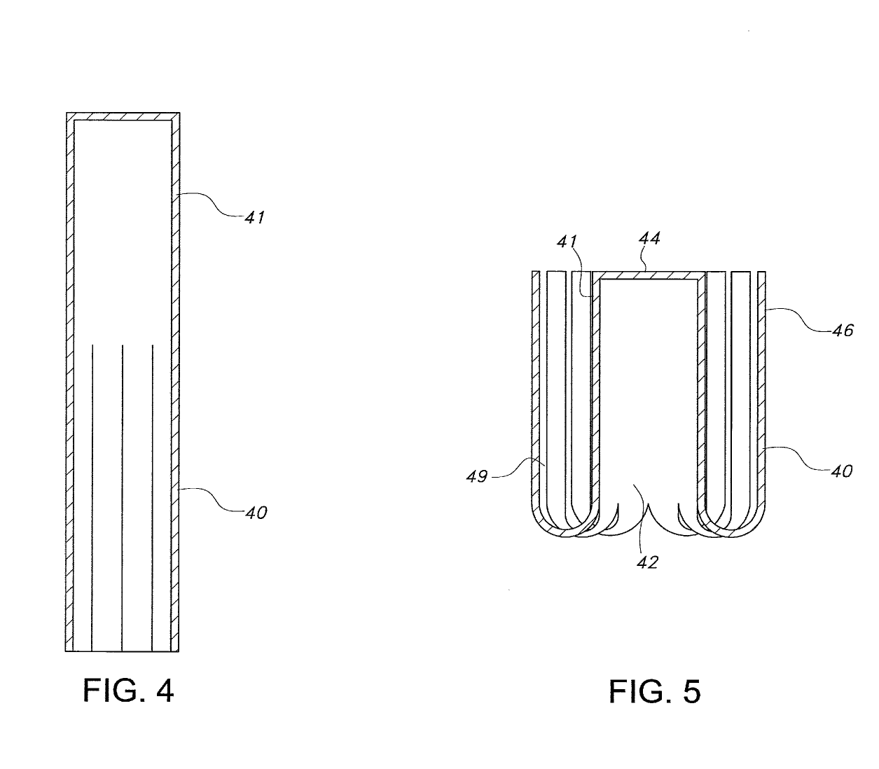

### DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

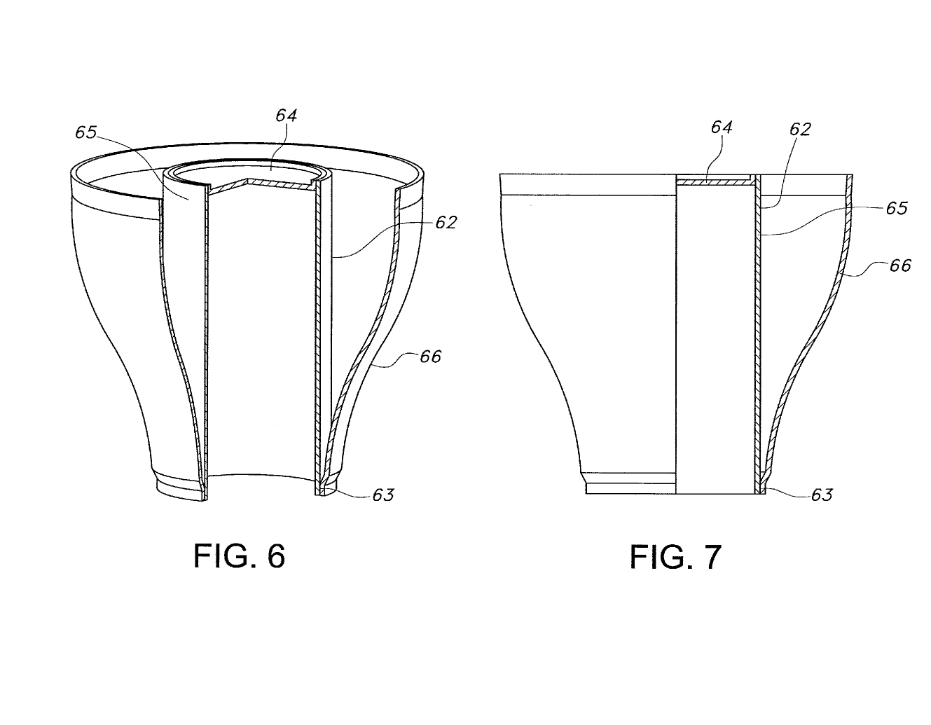

A side perspective partial cross-sectional view of a heat sink according to one embodiment is shown in FIG. 6, FIG. 7 represents a side view in partial cross-section of the same embodiment. In this embodiment, the outer shell 66, inner shell 62 and support plate 64 are separate components. The inner shell 62 and outer shell 66 are attached at attachment point 63 their respective second ends via a mechanical attachment. The support plate 64 covers the first end 65 of the inner shell 62. The support plate 64 sits inside the first end 65 of the inner shell 62 and is frictionally engaged with the inner shell. This embodiment does not include a face. Each of the inner shell 62, the support plate 64 and the outer shell 66 are in thermal communication.

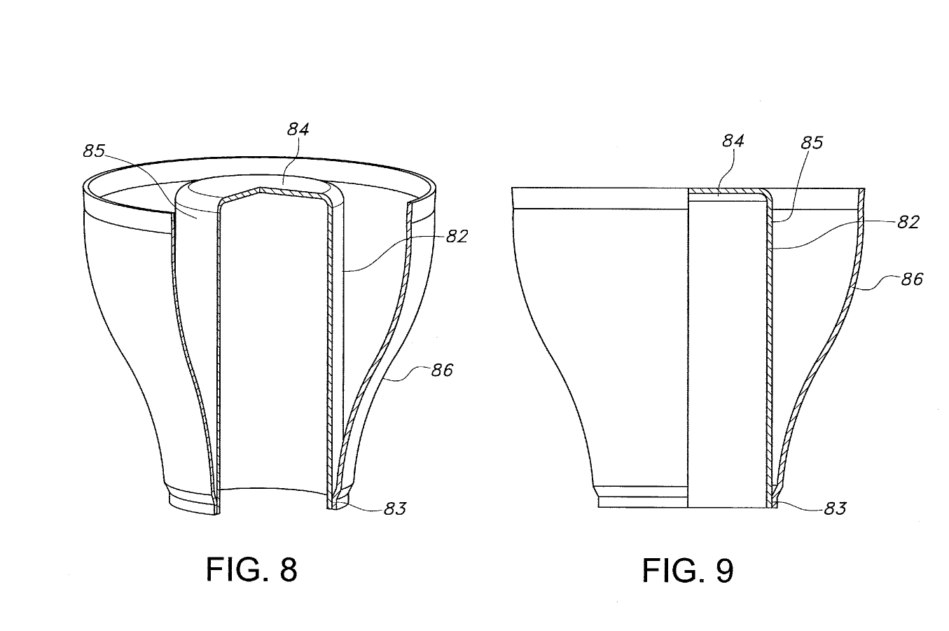

A side perspective partial cross-sectional view of a heat sink according to another embodiment is shown in FIG. 8. FIG. 9 represents a side view in partial cross-section of the same embodiment. In this embodiment, the inner shell 82 and the support plate 84 have been integrally formed as a unitary structure. The inner shell 82 and outer shell 86 are attached at attachment point 83 their respective second ends via a mechanical attachment. The support plate 84 covers the first end 85 of the inner shell 82. This embodiment does not include a face. Each of the inner shell 82, the support plate 84 and the outer shell 86 are in thermal communication.

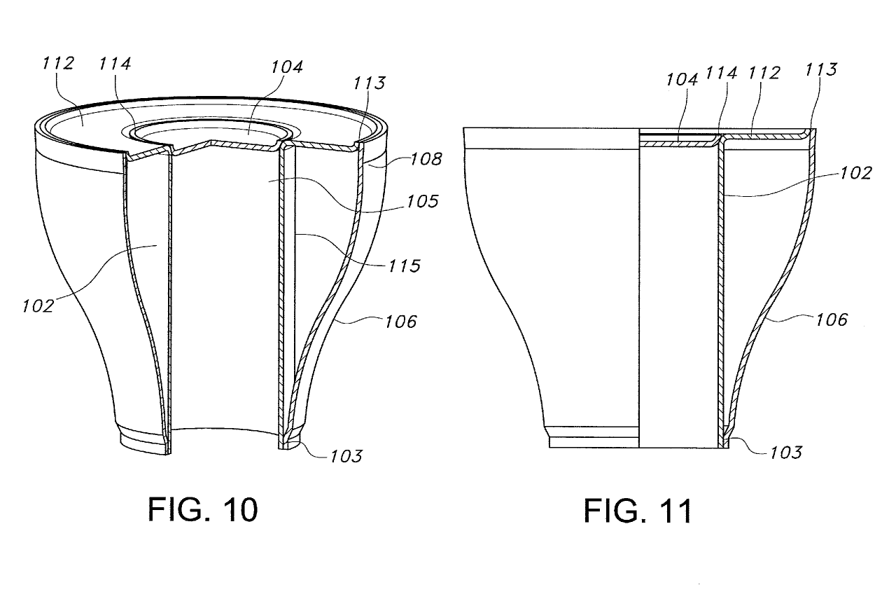

In the embodiment of the heat sink shown in FIG. 10 in a side perspective partial cross-section view, the inner shell 102 and the face 112 have been integrally formed as a unitary structure 115. FIG. 11 represents a side view in partial cross-section of the same embodiment. The inner shell 102 and the outer shell 106 are attached at attachment point 103 their respective second ends via a mechanical attachment. The support plate 104 covers the first end 105 of the inner shell 102. The support plate 104 has a lip 114 around its perimeter. The lip 114 rests on the center edge of the face 112. The outer perimeter of the face 112 is attached at attachment point 113 to the first end 108 of the outer shell 106 via mechanical attachment. Each of the outer shell 106, the inner shell 102, the support plate 104 and the face 112 are in thermal communication.

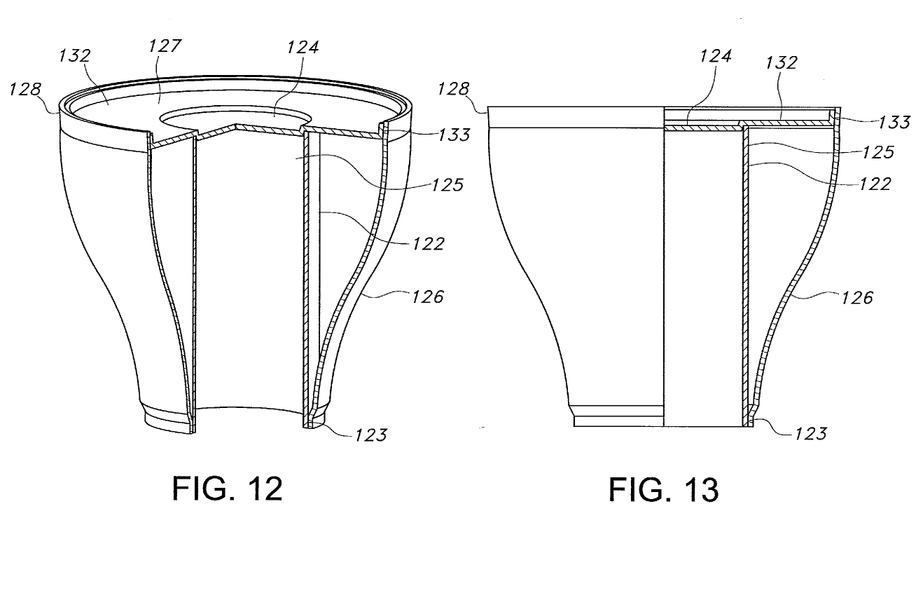

In the embodiment of the heat sink shown in FIG. 12 in a side perspective partial cross-section view, the support plate 124 and the face 132 have been integrally formed as a unitary structure 127. FIG. 13 represents a side view in partial cross-section of the same embodiment. The inner shell 122 and the outer shell 126 are attached at attachment point 123 at their respective second ends via a mechanical attachment. The support plate 124 forms a depression in the face 132. The outer perimeter of the face is attached to the first end 128 of the outer shell 126 at the attachment point 133 via mechanical attachment. The support plate 124 aligns with the first end 125 of the inner shell 122. Each of the outer shell 126, the inner shell 122, the support plate 124 and the face 132 are in thermal communication.

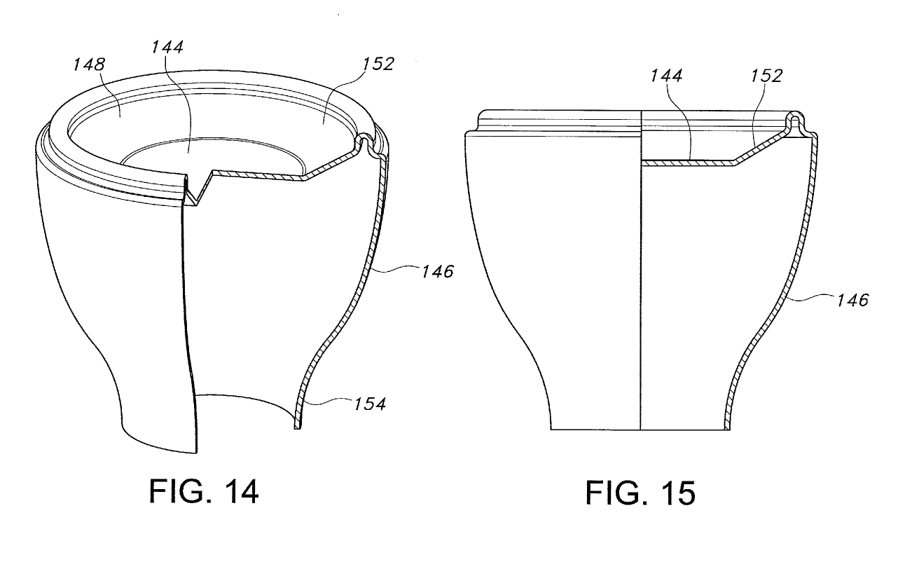

In the embodiments shown in FIG. 14 in a side perspective partial cross-section view, the outer shell 146, the support plate 144 and the face 152 have been integrally formed as a unitary structure. FIG. 15 represents a side view in partial cross-section of the same embodiment. An inner shell is not shown in FIGS. 14 and 15. A portion of the face 152 is at an angle of about 45° from a plane contacting the entire circumference of the first end of the outer shell 146. The angle of the face 152, especially when coated with a reflective material, enhances the output of an LED supported by the support plate 144. The angle and coating can be engineered for optimal reflection of light from an LED supported by the support plate 144. The embodiment shown in FIGS. 14 and 15 can be formed by drawing and redrawing or drawing and ironing an aluminum sheet, as is known in the can making art. A dome can be formed in the closed end of the structure formed from drawing and redrawing or drawing and ironing to form the support plate 144 and face 152. The dome can be formed by any method known in the art. In the embodiment shown in FIGS. 14 and 15, the thermally conductive metal outer shell 146 has a thickness less than 0.249 inch (6.3246 mm); a first closed end 148 having a first diameter and dimensioned to support an electronic component operably connected to the electrical circuit; and a second end having a second diameter, wherein the first diameter is greater than the second diameter and wherein the outer shell 146 is comprised of a single metal sheet and is a unitary structure.

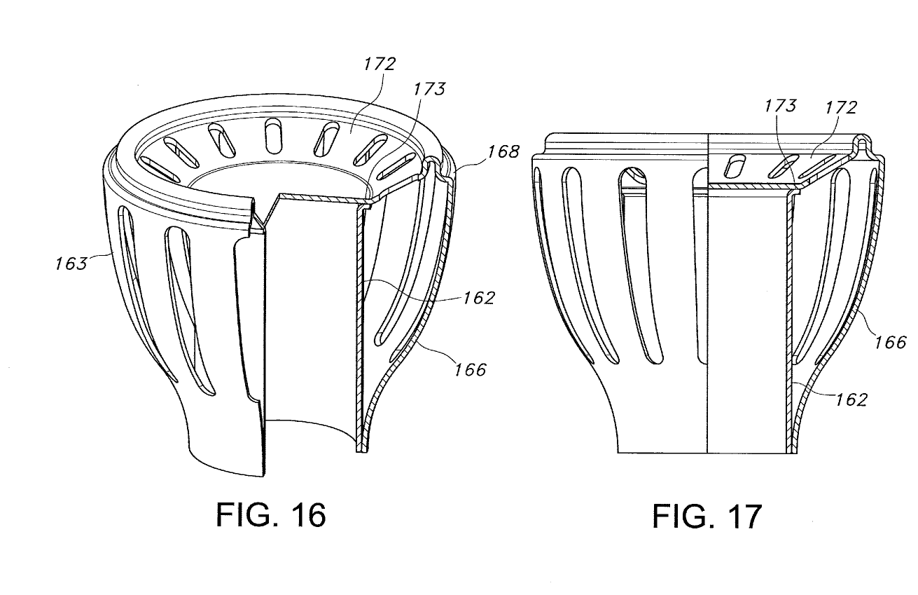

In the embodiment shown in FIG. 16 in a side perspective partial cross-section view, the outer shell 166 and the face 172 have been integrally formed as a unitary structure 163. FIG. 17 represents a side view in partial cross-section of the same embodiment. A support plate is not shown in FIGS. 16 and 17. The face 172 is at an angle of about 45° from a plane contacting the entire circumference of the first end 168 of the outer shell 166. The outer shell 166 and the face 172 have slotted apertures. The embodiment shown in FIGS. 16 and 17 can be formed by drawing and redrawing or drawing and ironing an aluminum sheet, as is known in the can making art. A dome can cover the first end 168 of the outer shell 166. The dome can be formed by any method known in the art. The center of the face 172 and the apertures in the face and in the outer shell 166 can be made by electromagnetic forming or by any method known in the art. The inner shell 162 is attached to the face 172 at attachment point 173.

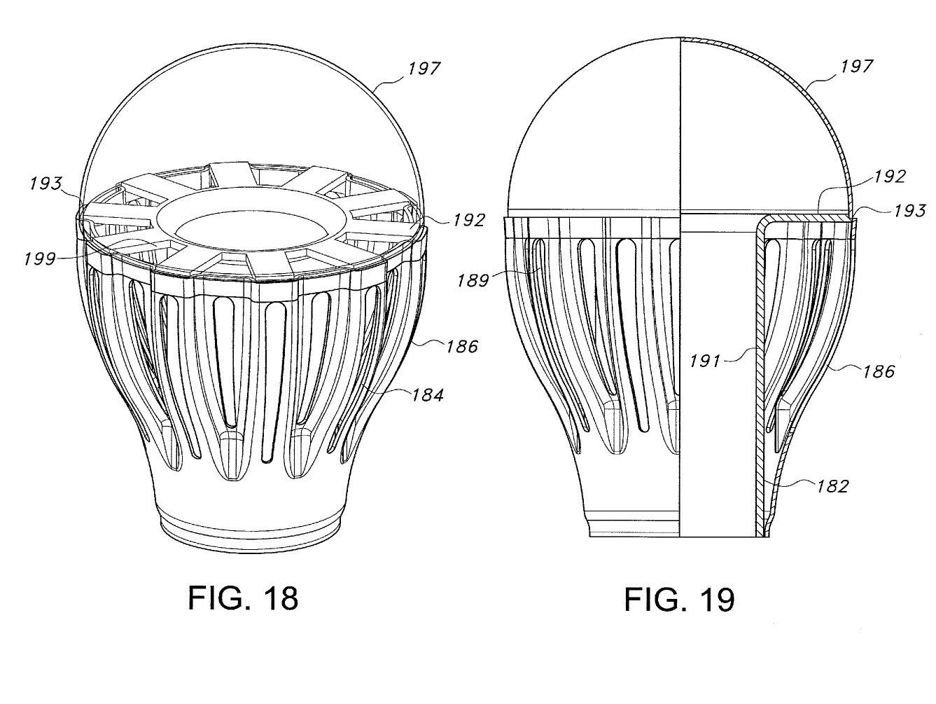

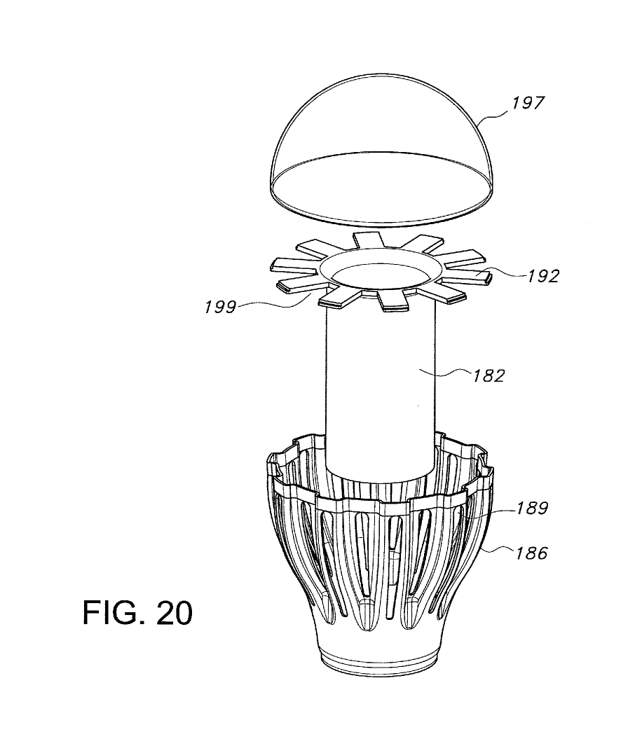

A side perspective view of one embodiment for a housing for an LED is shown in FIG. 18. FIG. 19 represents a side view in partial cross-section of the same embodiment and FIG. 20 shows an exploded view of the same embodiment. The embodiment shown in FIGS. 18, 19 and 20 includes an outer shell 186, an inner shell 182 and a face 192 as a unitary structure 191, and a dome 197 covering the face 172. A support plate is not shown. The outer shell 186 has slotted apertures 189 and the face has triangular apertures 199. The face 192 is attached to the outer shell 186 at the attachment point 193. The outer shell is corrugated.

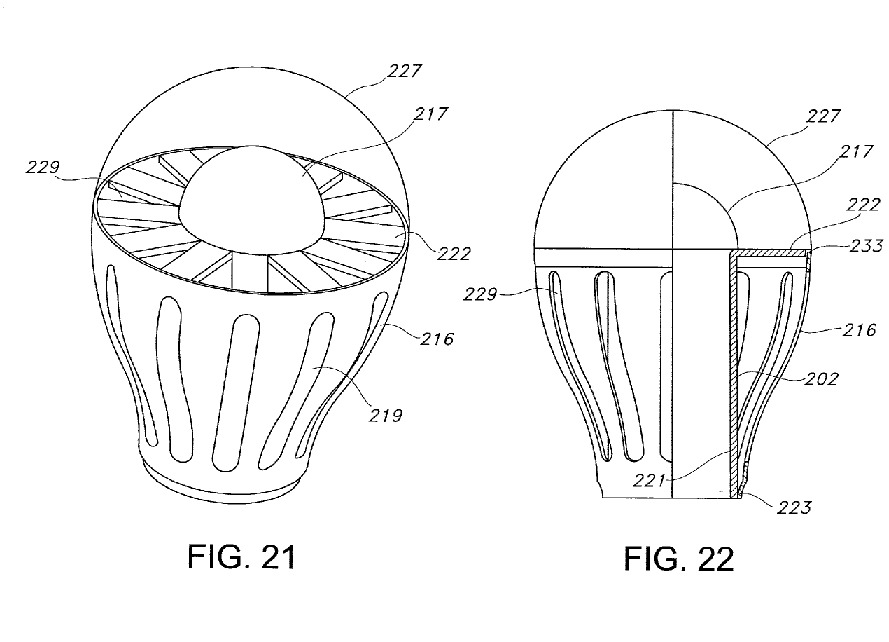

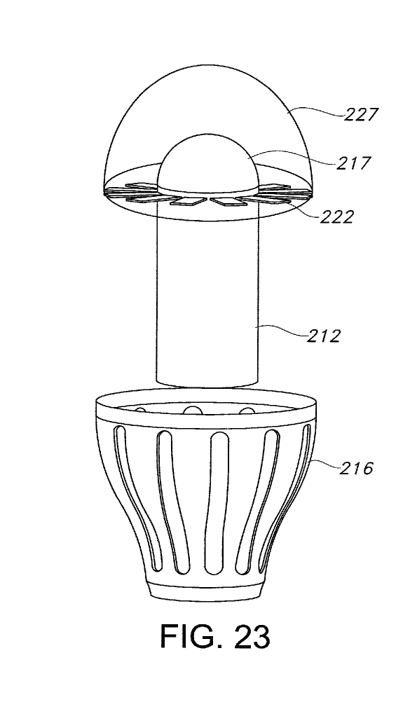

A side perspective view of another embodiment for a housing for an LED is shown in FIG. 21. FIG. 22 represents a side view in partial cross-section of the same embodiment and FIG. 23 shows an exploded view of the same embodiment. The embodiment shown in FIGS. 21, 22 and 23 includes an inner shell 212 and a face 222 as a unitary structure 221, an outer face 216, an outer dome 227 covering the face 22 and an inner dome 217 situated to cover a support plate 214 and an LED. The support plate and LED are not shown. The outer shell 216 has slotted apertures 219 and the face 222 has triangular apertures 229. This embodiment enables an LED to be protected while air is drawn in through the apertures 219 in the outer shell and passes through the apertures 229 in the face 222 between the inner dome 217 and the outer dome 227. The inner shell 202 is attached to the outer shell 216 at the attachment point 223 and the face 222 is attached to the outer shell 216 at the attachment point 233.

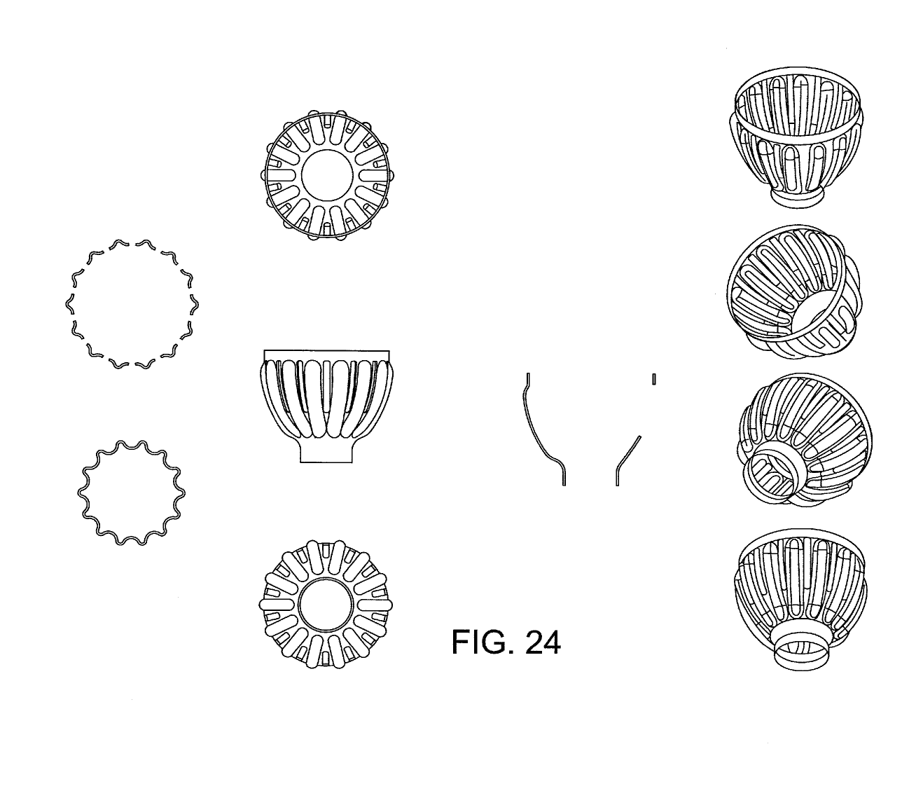

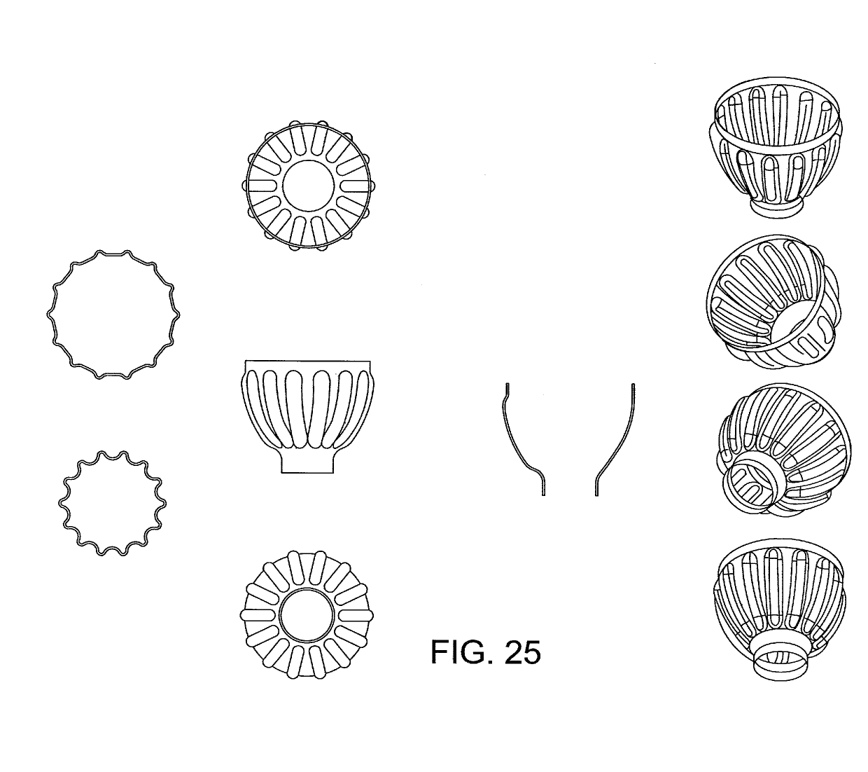

FIG. 24 shows several views of an outer shell that may form part of a heat sink according to some embodiments. The outer shell shown in FIG. 24 has slotted apertures and is corrugated. The first end of the outer shell has a larger diameter than the second end of the outer shell and the outer shell shown in FIG. 24 is generally tapered from the first end to the second end.

FIG. 25 shows several views of an outer shell that may form part of a heat sink according to some embodiments. The outer shell shown in FIG. 25 has no apertures between the first end and the second end and is corrugated. The first end of the outer shell has a larger diameter than the second end of the outer shell and the outer shell shown in FIG. 25 is generally tapered from the first end to the second end.

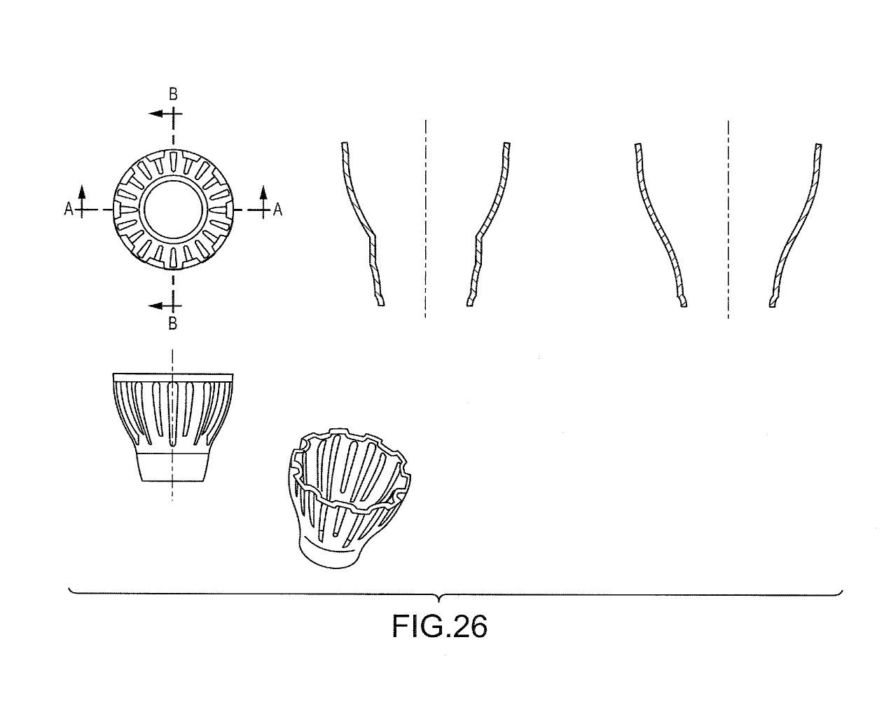

FIG. 26 shows several views of an outer shell that may form part of a heat sink according to some embodiments. The outer shell shown in FIG. 26 has slotted apertures and is corrugated. The first end of the outer shell has a larger diameter than the second end of the outer shell.

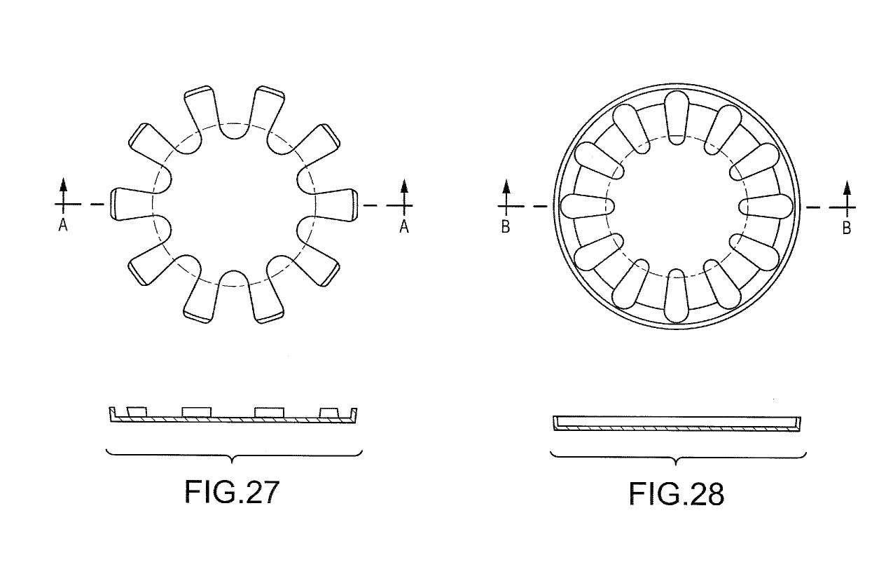

FIG. 27 shows a top view and a side view of a support plate and a face as a unitary structure. The structure has grooves that will form apertures when the outer perimeter is frictionally engaged with the inner diameter of the first end of an outer shell.

FIG. 28 shows a top view and a side view of a support plate and a face as a unitary structure. The structure has slotted apertures and is dimensioned to frictionally engage with the inner diameter of the first end of an outer shell.

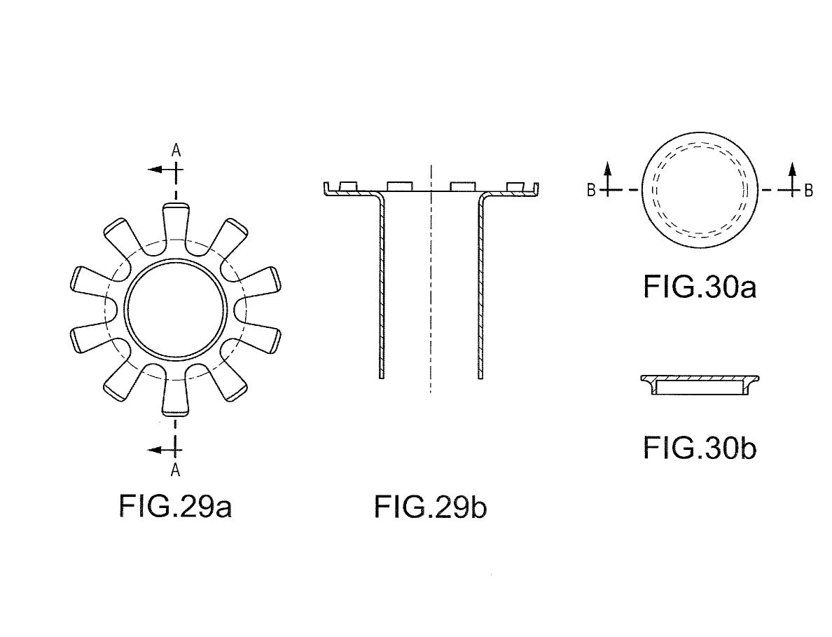

FIG. 29a shows a top view of an inner shell and a face as a unitary structure. The structure has grooves that will form apertures when the outer perimeter of the face is frictionally engaged with the inner diameter of the first end of an outer shell. A side cross-sectional view of structure is shown in FIG. 29b.

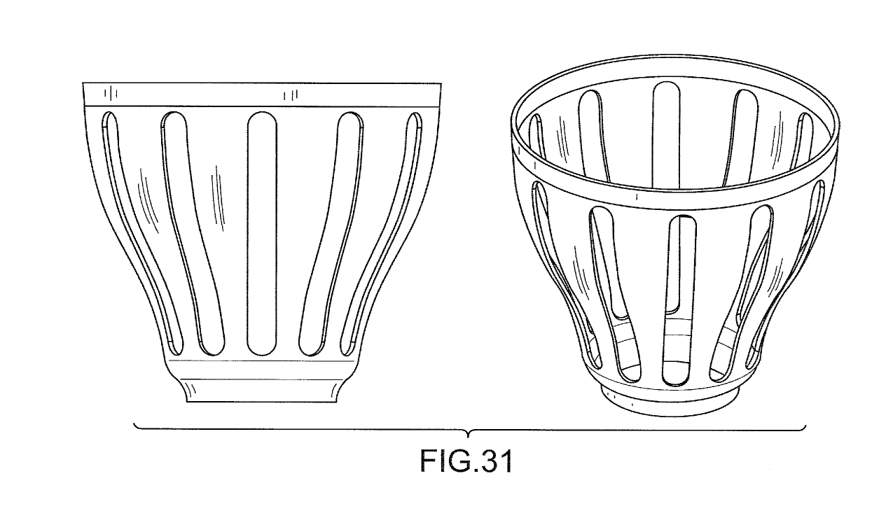

FIG. 30a shows a top view of a support plate dimensioned to cover the inner shell and rest upon the inner diameter of the face shown in FIGS. 29a and 29b. FIG. 30b shows a cross-section of the support plate.

FIG. 31 shows a side view and a side perspective view of an outer shell that may form part of a heat sink according to some embodiments. The outer shell shown in FIG. 31 has slotted apertures and is not corrugated. The slots are 5 mm wide and are in a regular pattern.

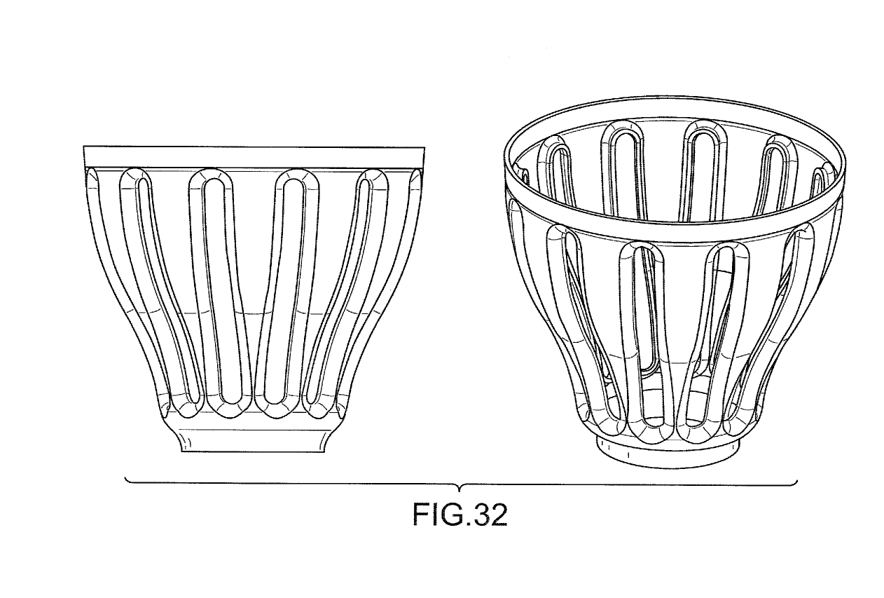

FIG. 32 shows a side view and a side perspective view of an outer shell that may form part of a heat sink according to some embodiments. The outer shell shown in FIG. 32 has slotted apertures and is not corrugated. The slots are 4 mm wide and are in a regular pattern. The edges of the slots are beveled and form corrugations on the inside of the outer shell.

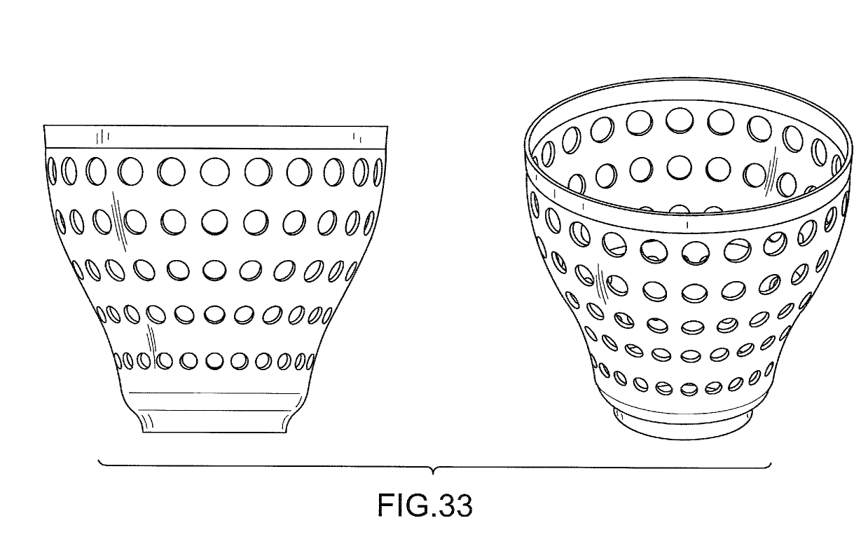

FIG. 33 shows a side view and a side perspective view of an outer shell that may form part of a heat sink according to some embodiments. The outer shell shown in FIG. 33 has circular apertures and is not corrugated. The circular apertures have varying diameters. The diameter of the apertures in a row most proximate to the first end is 5 mm. The diameter of the apertures is smaller with each consecutive row moving toward the second end. The diameter of the apertures in a row most proximate to the second end is 3 mm.

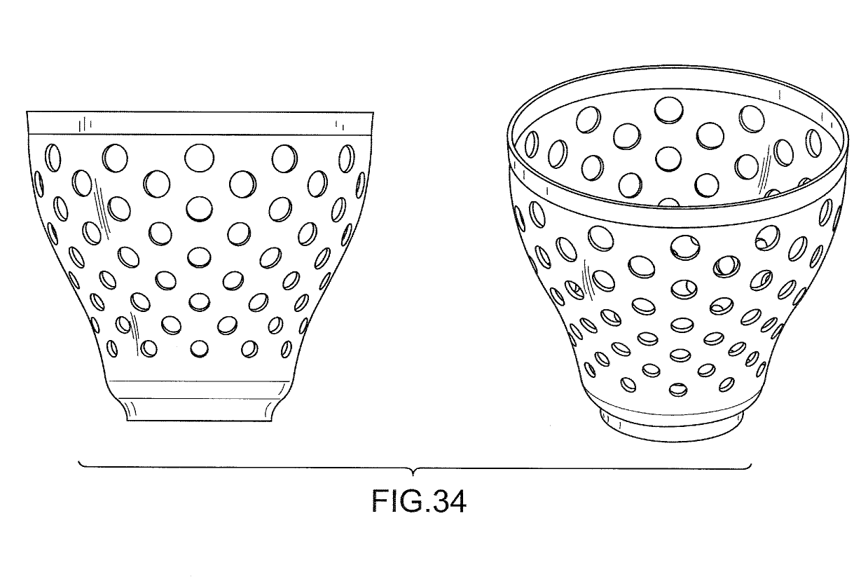

FIG. 34 shows a side view and a side perspective view of an outer shell that may form part of a heat sink according to some embodiments. The outer shell shown in FIG. 34 has circular apertures and is not corrugated. The circular apertures have varying diameters. The diameter of the apertures in a row most proximate to the first end is 5 mm. The diameter of the apertures is smaller with each consecutive row moving toward the second end. The diameter of the apertures in a row most proximate to the second end is 3 mm.

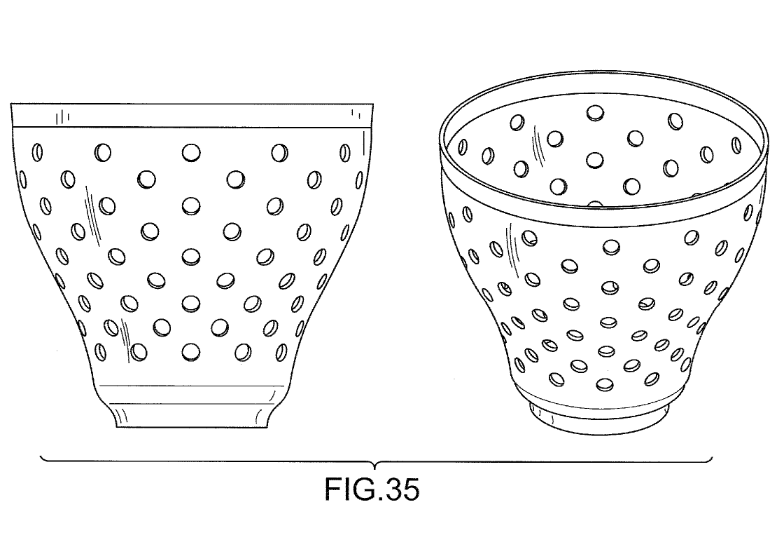

FIG. 35 shows a side view and a side perspective view of an outer shell that may form part of a heat sink according to some embodiments. The outer shell shown in FIG. 35 has circular apertures and is not corrugated. The circular apertures have 3 mm diameters.

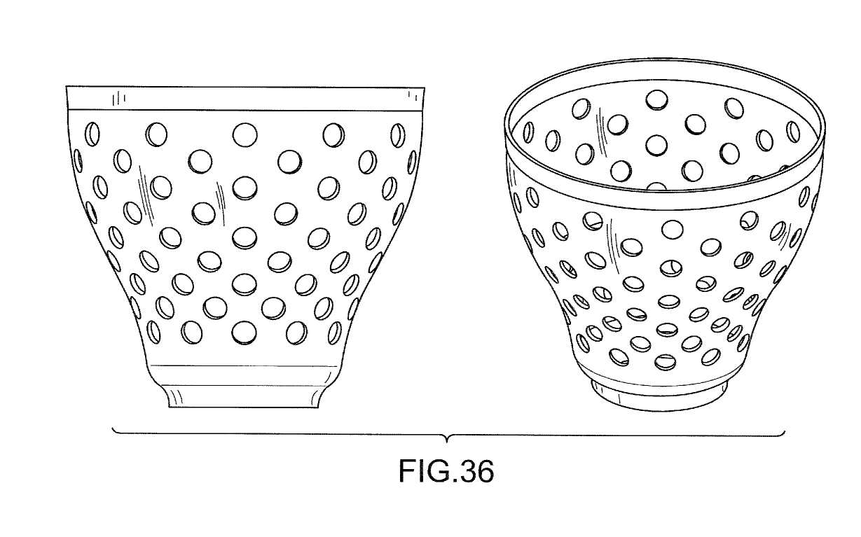

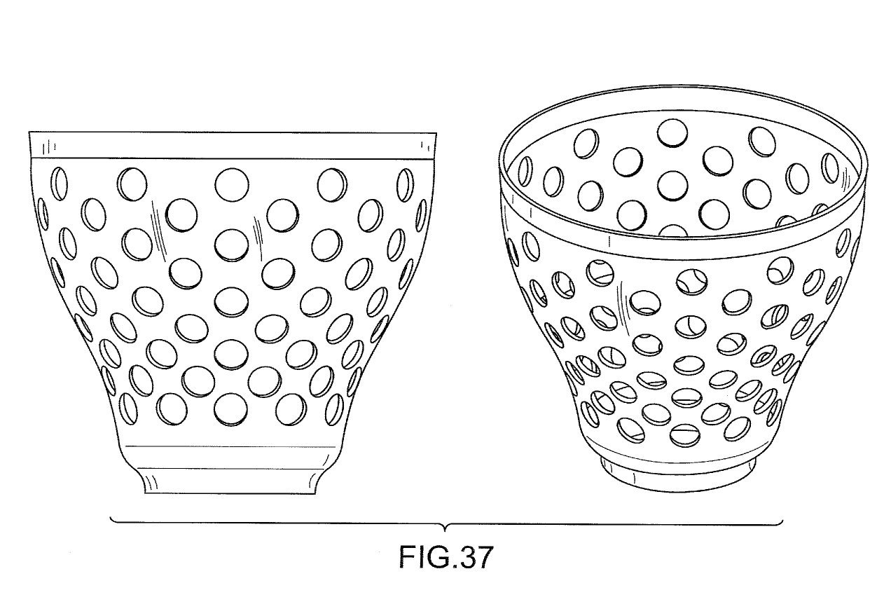

FIGS. 36 and 37 are is similar to FIG. 35, except the circular apertures have 4 mm diameters and 5 mm diameters, respectively.

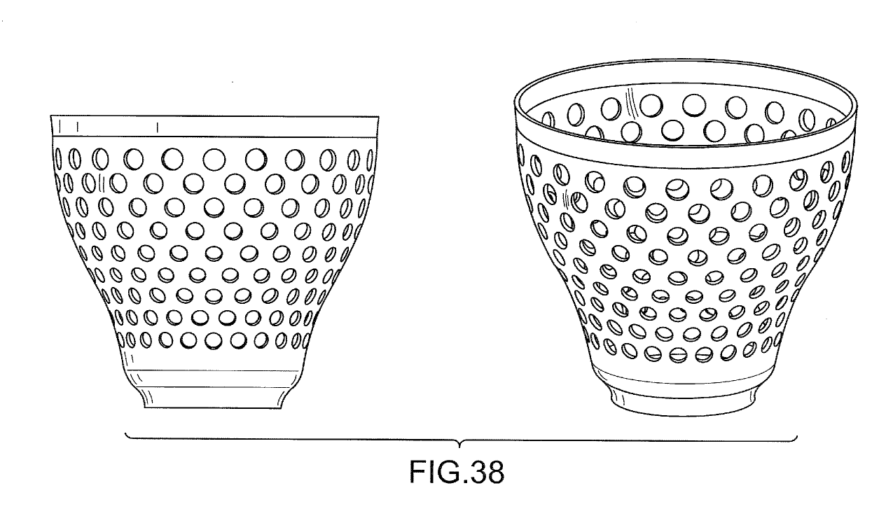

FIG. 38 shows a side view and a side perspective view of an outer shell that may form part of a heat sink according to some embodiments. The outer shell shown in FIG. 38 has circular apertures and is not corrugated. The circular apertures have varying diameters. The diameter of the apertures in a row most proximate to the first end is 4 mm. The diameter of the apertures is smaller with each consecutive row moving toward the second end. The diameter of the apertures in a row most proximate to the second end is 3 mm.

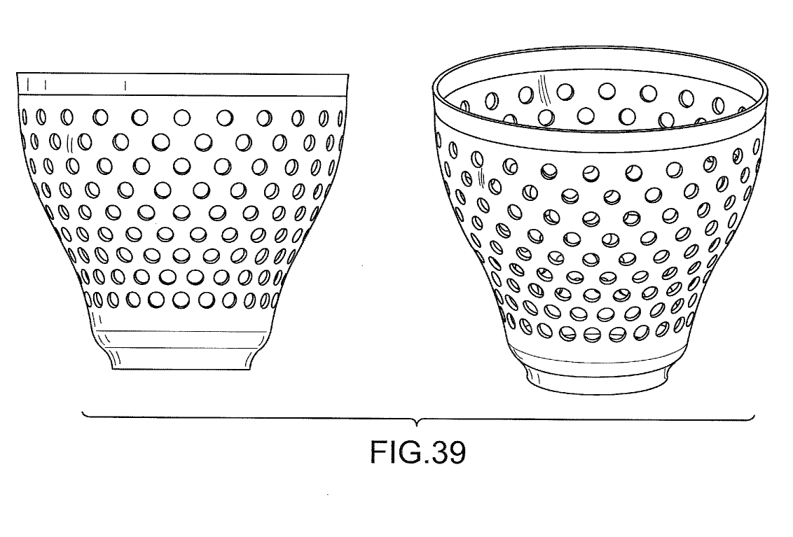

FIG. 39 shows a side view and a side perspective view of an outer shell that may form part of a heat sink according to some embodiments. The outer shell shown in FIG. 39 has circular apertures and is not corrugated. The circular apertures have 3 mm diameters.

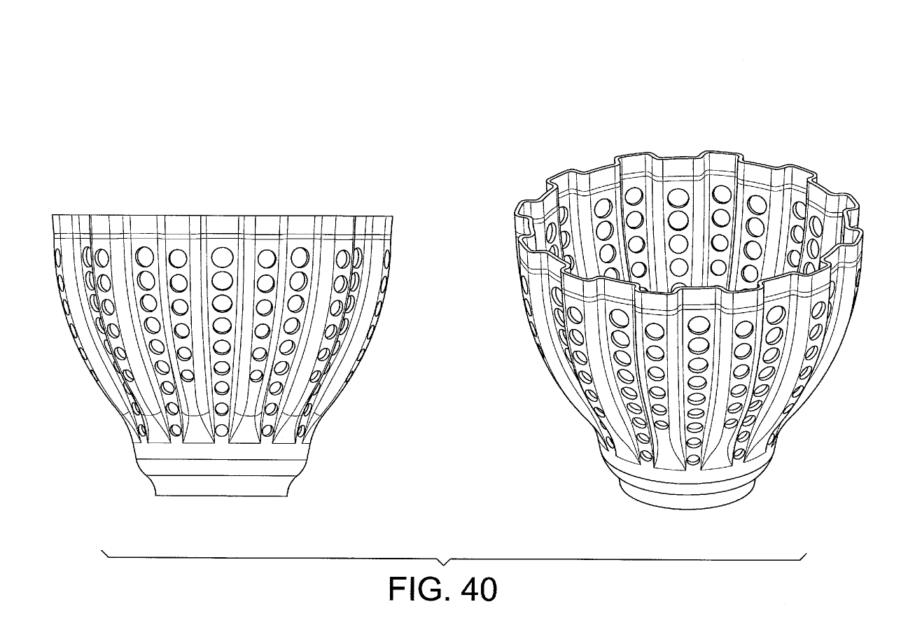

FIG. 40 shows a side view and a side perspective view of an outer shell that may form part of a heat sink according to some embodiments. The outer shell shown in FIG. 40 has circular apertures and is corrugated. The circular apertures have varying diameters. The diameter of the apertures in a row most proximate to the first end is 4 mm. The diameter of the apertures is smaller with each consecutive row moving toward the second end. The diameter of the apertures in a row most proximate to the second end is 2.4 mm.

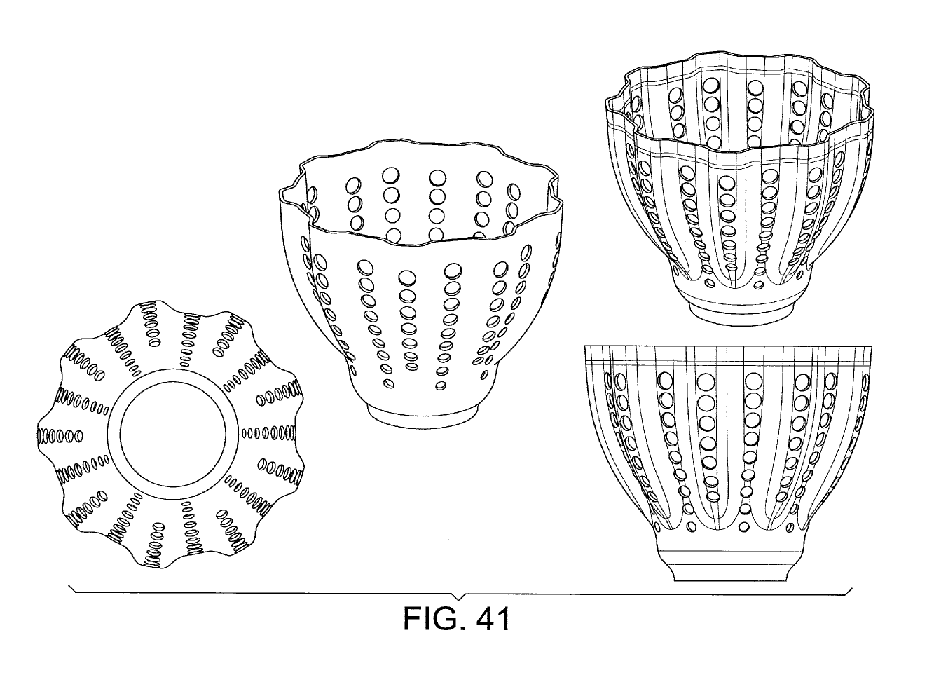

The outer shell shown in FIG. 41 is similar to the outer shell shown in FIG. 40, except the shape of the corrugations is different.

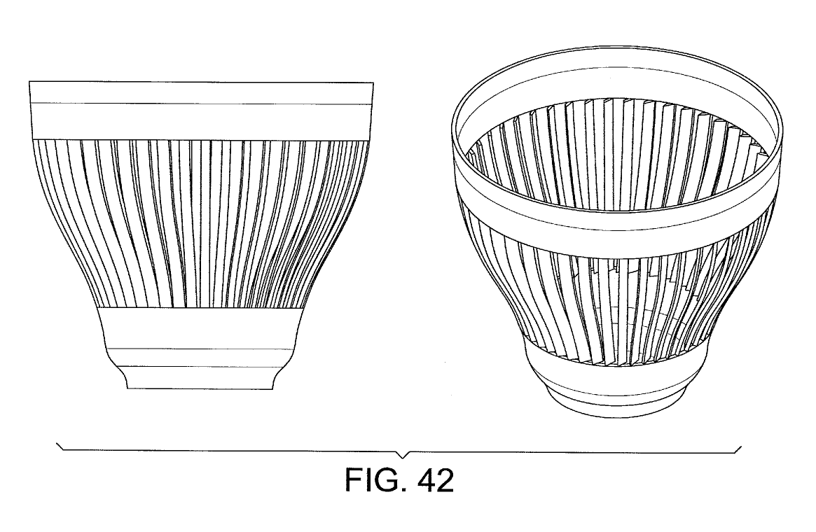

FIG. 42 shows a side view and a side perspective view of an outer shell that may form part of a heat sink according to some embodiments. The outer shell shown in FIG. 42 has louvers forming apertures.

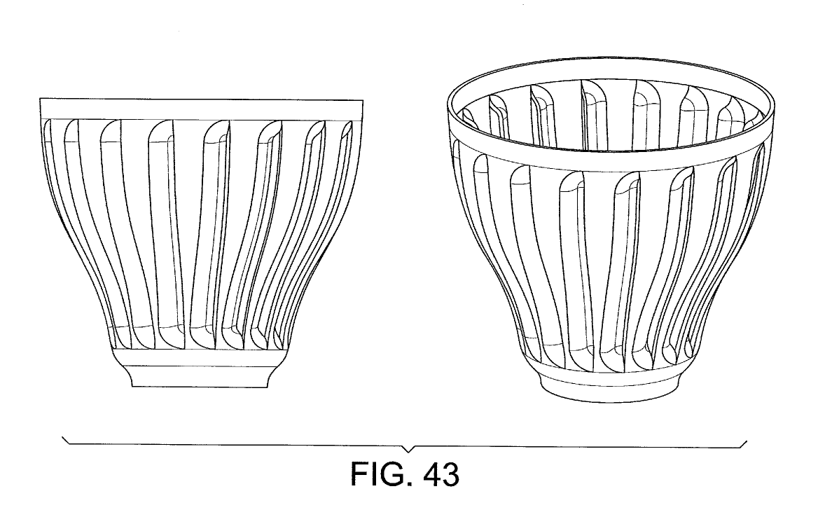

FIG. 43 shows a side view and a side perspective view of an outer shell that may form part of a heat sink according to some embodiments. The outer shell shown in FIG. 43 has louvers forming apertures. An edge of each of the louvers is beveled and forms a corrugating on the inside of the outer shell.

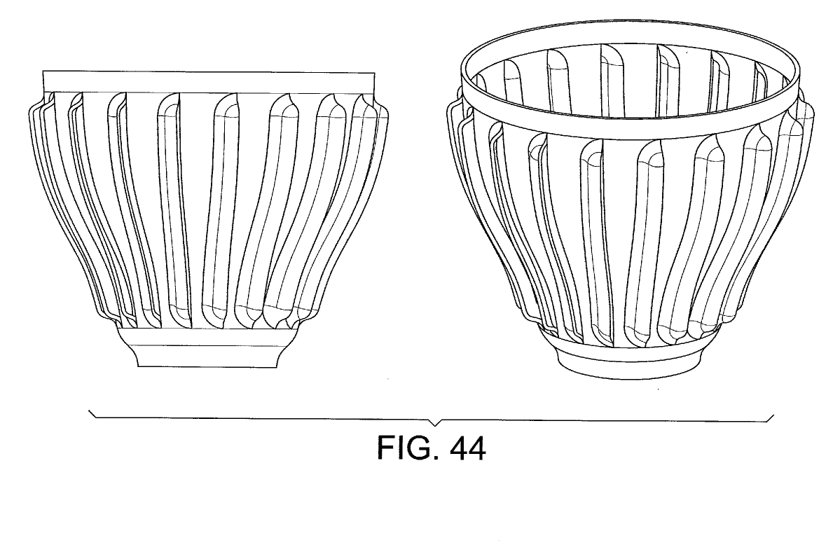

FIG. 44 shows a side view and a side perspective view of an outer shell that may form part of a heat sink according to some embodiments. The outer shell shown in FIG. 44 has louvers forming apertures. An edge of each of the louvers is beveled and forms a corrugating on the outside of the outer shell.

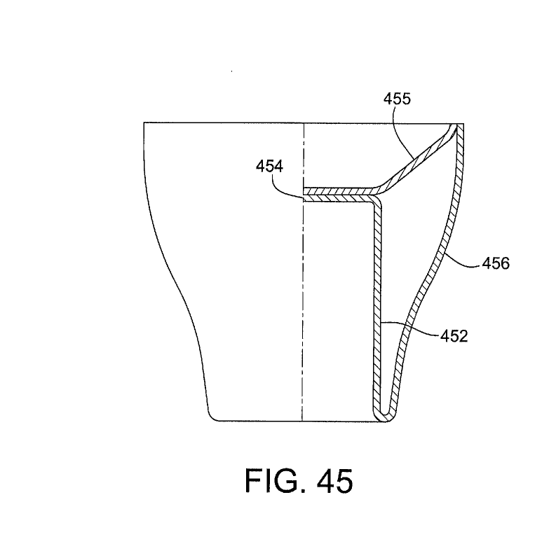

With respect to FIG. 45, the outer shell 456 and the inner shell 452 and the support plate 454 are one integrated unit, aka a unitary structure. The face 455 aids in heat transfer as well as reflectivity.

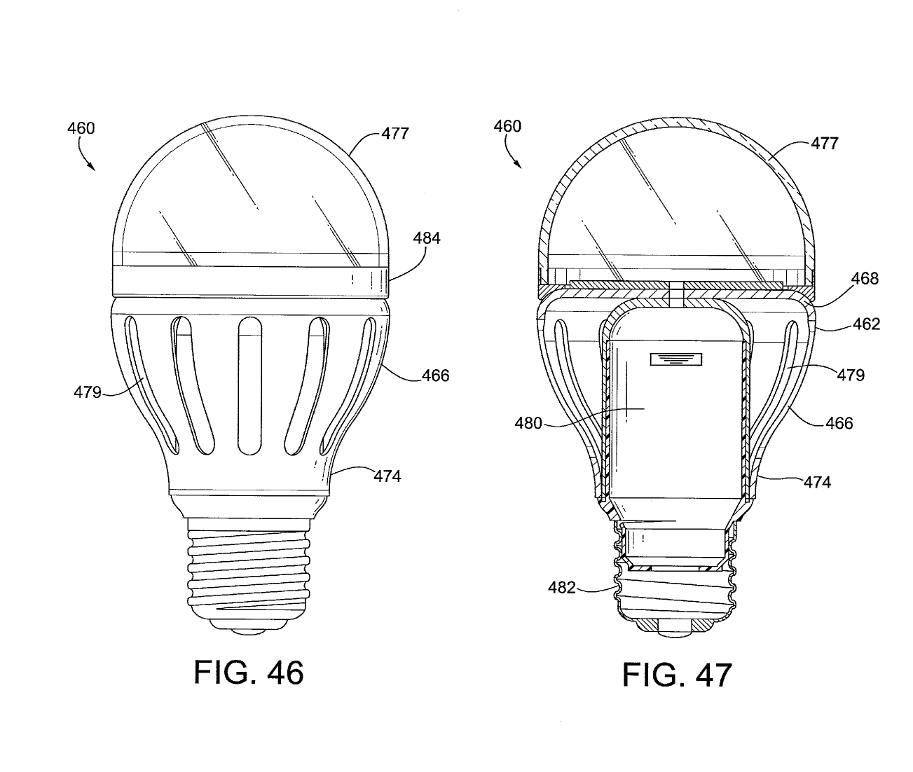

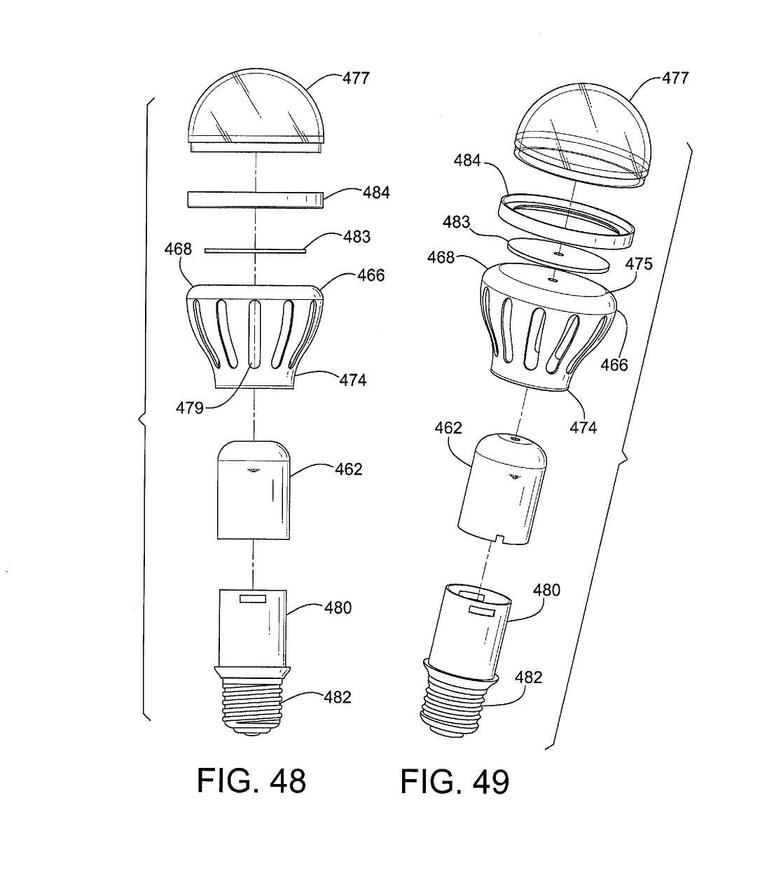

FIGS. 46-49 show an example of an LED lighting device 460 according to one embodiment of the invention. The LED lighting device 460 comprises: an inner shell 462 dimensioned to house an electrical circuit; and a thermally conductive metal outer shell 466. The inner shell 462 is at least partially within the outer shell 466 and the outer shell is comprised of a single metal sheet. The thermally conductive metal outer 466 shell has a thickness less than 0.249 inch (6.3246 mm); a first closed end 468 having a first diameter and dimensioned to support the LED board 483 operably connected to the electrical circuit; and a second end 474 having a second diameter. The first diameter is greater than the second diameter. The LED board 483 supported by the first closed end 468 would be in thermal communication with the outer shell 466.

The inner shell 462 comprised of metal. In some embodiments, the inner shell 462 is comprised of a single metal sheet. A plastic circuit housing 480 attached to a base 482 is also shown.

The thickness of the metal outer shell 466 decreases from the first closed end 468 to the second end 474. The second end 474 of the outer shell 466 is in physical contact with the inner shell 462 proximate to a second end 478 of the inner shell 462.

The outer shell 466 has a plurality of apertures 479 between the first end 468 and the second end 474 of the outer shell.

When heat is generated by an LED on the LED board 483, which is in thermal communication the first closed end 468 of the thermally conductive outer shell 466, air is drawn through the apertures 479 and cools via convention at least one of the inner shell 462, the outer shell 466 and the LED board 483.

The outer surface of the metal outer shell 466 is flat. The first closed end 468 of the outer shell 466 has a light reflector 475.

A dome 477 covers the first closed end 468 of the metal outer shell 466. The dome 477 is transparent or translucent to light. A dome ring 484 attaches the dome 477 to the first end 468 of the outer shell 466. As can be seen, the closed first end 468 of the outer shell 466 the top of the inner shell 462 and the LED board 483 each have a hole to accommodate wires connecting LED's to electronics housed in the plastic circuit housing 480.

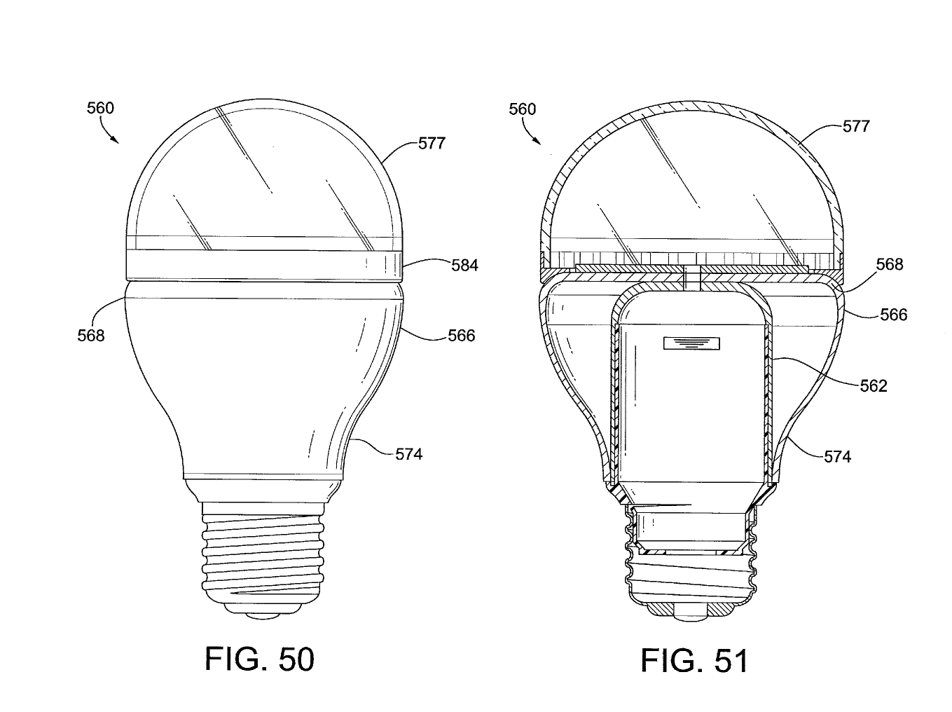

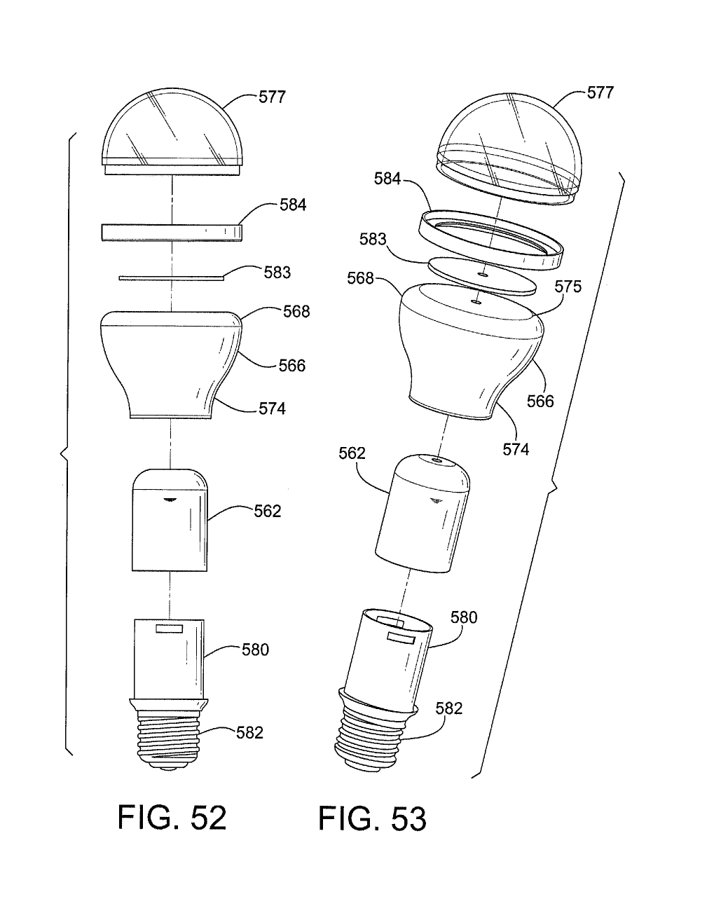

FIGS. 50-53 show another example of an LED lighting device 560 according to one embodiment of the invention. The LED lighting device 560 comprises: an inner shell 562 dimensioned to house an electrical circuit; and a thermally conductive metal outer shell 566. The inner shell 562 is at least partially within the outer shell 566 and the outer shell is comprised of a single metal sheet. The thermally conductive metal outer 566 shell has a thickness less than 0.249 inch (6.3246 mm); a first closed end 568 having a first diameter and dimensioned to support the LED board 583 operably connected to the electrical circuit; and a second end 574 having a second diameter. The first diameter is greater than the second diameter. The LED board 583 supported by the first closed end 568 would be in thermal communication with the outer shell 566.

The inner shell 562 comprised of metal. In some embodiments, the inner shell 562 is comprised of a single metal sheet. A plastic circuit housing 580 attached to a base 582 is also shown.

The thickness of the metal outer shell 566 decreases from the first closed end 568 to the second end 574. The second end 574 of the outer shell 566 is in physical contact with the inner shell 562 proximate to a second end 578 of the inner shell 562.

The outer surface of the metal outer shell 566 is flat. The first closed end 568 of the outer shell 566 has a light reflector 575.

A dome 577 covers the first closed end 568 of the metal outer shell 566. The dome 577 is transparent or translucent to light. A dome ring 584 attaches the dome 577 to the first end 568 of the outer shell 566. As can be seen, the closed first end 568 of the outer shell 566 the top of the inner shell 562 and the LED board 583 each have a hole to accommodate wires connecting LED's to electronics housed in the plastic circuit housing 580.

In this embodiment, the outer shell 566 has no apertures except for the hole to accommodate wires,

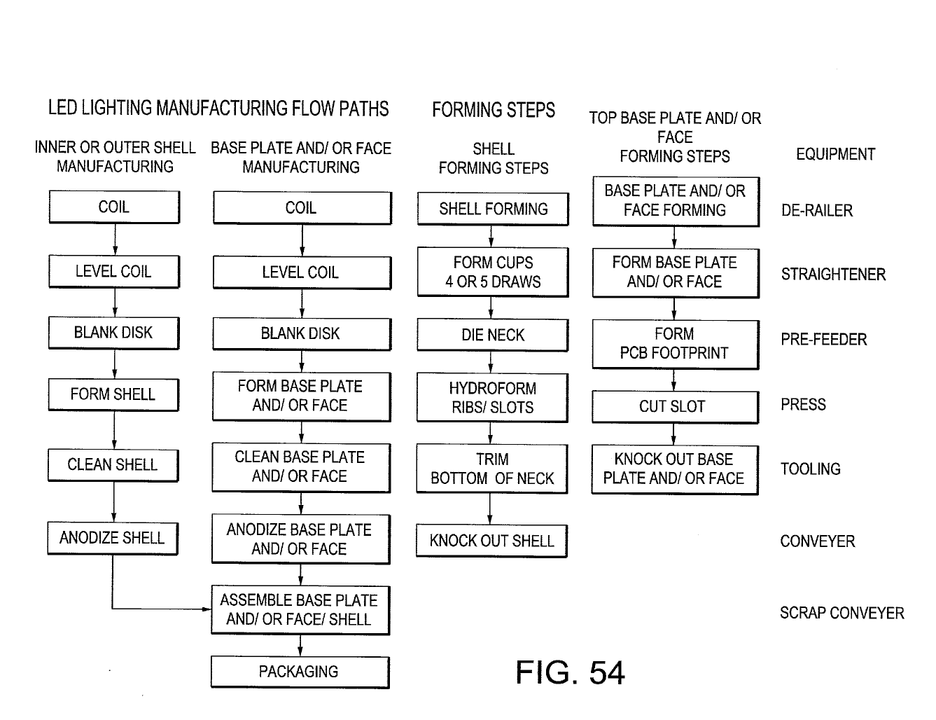

FIG. 54 shows a possible manufacturing flow path to manufacture one embodiment of a heat sink.

Although the present invention has been described in considerable detail with reference to certain versions thereof, other versions are possible. Therefore, the spirit and scope of the appended claims should not be limited to the description of the versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means or step for” clause as specified in 35 U.S.C. §112.

1. A device comprising:
an inner shell dimensioned to house an electrical circuit;
a thermally conductive metal outer shell comprising:
a thickness less than 0.249 inch (6.3246 mm):
a first closed end having a first diameter and dimensioned to support an electronic component operably connected to the electrical circuit; and
a second end having a second diameter,
wherein the first diameter is greater than the second diameter;
wherein the inner shell is at least partially within the outer shell; and
wherein the outer shell is comprised of a single metal sheet.

2. The device of claim 1 wherein the outer shell is in physical contact with the inner shell.

3. The device of claim 2 wherein the second end of the outer shell is in physical contact with the inner shell proximate to a second end of the inner shell.

4. The device of claim 1 further comprising a plurality of apertures in the outer shell between the first end and the second end of the outer shell.

5. The device of claim 4 wherein when heat is generated by an electronic component in thermal communication the first closed end of the thermally conductive outer shell, air is drawn through the apertures and cools via convention at least one of the inner shell, the outer shell and the electronic component.

6. The device of claim 1 wherein the metal sheet is aluminum sheet.

7. The device of claim 1 wherein an outer surface of the metal outer shell is flat.

8. The device of claim 1 wherein an outer surface of the metal outer shell is corrugated.

9. The device of claim 1 wherein at least a portion of a surface of the outer shell has an Ra value in the range of 6.5 μin to 200 μin.

10. The device of claim 1 wherein the outer shell has a textured surface finish wherein the texture is created by one of mechanical roughening and coating.

11. The device of claim 1 wherein the outer shell is at least partially coated with graphite.

12. The device of claim 1 wherein the outer shell is comprised of one of AA 1050, 1100, 3003, 3004 and 3104.

13. The device of claim 1 wherein the electronic component is a light emitting diode.

14. The device of claim 1 further comprising a dome covering the first closed end of the metal outer shell, wherein the dome is transparent or translucent to light.

15. The device of claim 1 further comprising a light reflector on the first closed end of the metal outer shell.

16. The device of claim 1 wherein the inner shell comprised of metal.

17. The device of claim 1 wherein the inner shell is comprised of a single metal sheet.

18. The device of claim 1 wherein the inner shell is comprised of plastic.

19. The device in claim 1 wherein the thickness of the metal outer shell decreases from the first closed end to the second end.

20. The device of claim 19 wherein the thinnest portion of the outer metal shell is less than or equal to 0.75 times the thickest portion of the outer metal shell.
